(19) United States
(12) Patent Application Publication
(10) Pub. No.: US 2014/0289663 A1
(43) Pub. Date: Sep. 25, 2014

(54) Producing Artwork Based on an Imported Image

(71) Applicant: MICROSOFT CORPORATION, Redmond, WA (US)

(72) Inventors: Fan Zhang, Redmond, WA (US); John A. Szofran, Seattle, WA (US); Subha Bhattacharyay, Medina, WA (US); Kaushik Barat, Redmond, WA (US); Ira L. Snyder, JR., Bellevue, WA (US); Gerard Zytnicki, Seattle, WA (US); Christopher S. Lester, Redmond, WA (US); Nicholas R. Barling, Redmond, WA (US); Jeffrey A. Herold, Kirkland, WA (US); Hans Thomas Landsberger, Greenwich, CT (US)

(73) Assignee: Microsoft Corporation, Redmond, WA (US)

(21) Appl. No.: 13/890,250

(22) Filed: May 9, 2013

Related U.S. Application Data
(60) Provisional application No. 61/804,184, filed on Mar. 21, 2013.

(51) Int. Cl. G06F 3/0484

(52) U.S. Cl. CPC G06F 3/0484
USPC 715/771

(57) ABSTRACT

A painting system is described herein for producing artwork. In one implementation, the painting system operates by receiving an input image of any type from any source. The painting system then imports the input image into a painting mechanism. Thereafter, the painting system allows a user to produce artwork by modifying the input image, as if the input image constituted paint that the user applied in manual fashion using the painting mechanism. This technology facilitates the production of artwork, as the user can leverage an already-existing image in producing the artwork.

This application claims the benefit of U.S. Provisional Application No. 61/804,184 (the '184 application), filed Mar. 21, 2013. The '184 application is incorporated by reference herein in its entirety.

### BACKGROUND

Developers have proposed various painting applications which simulate the application of paint to a canvas to produce artwork. In these applications, the user first chooses the properties of a blank canvas, colors in a palette, etc. The user then uses one or more selected brushes to successively add paint strokes to the canvas until the artwork is finished. Some users, however, may consider this process of producing a digital artwork a daunting task. As a result, these users may be discouraged from using this kind of painting application.

### SUMMARY

A painting system is described herein for producing artwork. In one implementation, the painting system operates by receiving an input image of any type from any source. For example, the input image may correspond to a digital photograph. The painting system then imports new paint into a painting mechanism, where that new paint is based on the input image; in so doing, the painting system treats the input image as wet or dry paint (or both). Thereafter, the painting system allows a user to produce artwork by modifying the new paint using the painting mechanism. According to one potential benefit, the painting system facilitates the production of artwork, as the user can leverage an already-existing image in producing the artwork.

According to another illustrative aspect, the painting system includes a filtering module that uses at least one filter to transform the input image into a transformed image. Without limitation, the transformation performed by the filtering module corresponds to one or more of: producing an outline of image content in the input image based on edges detected in the input image; producing a color-faded version of the input image; producing a ridge-enhanced version of the input image; and producing a style-converted version of the input image based on a specified painting style, and so on.

The above approach can be manifested in various types of systems, components, methods, computer readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a painting system that produces artwork based on an imported image.

FIG. 2 shows a transformation mechanism that may be used by the painting system of FIG. 1.

FIG. 3 shows one workflow for producing artwork using the painting system of FIG. 1. Here, the user imports an input image onto a blank simulated canvas, e.g., with no pre-existing paint applied thereto.

FIG. 4 shows another workflow for producing artwork using the painting system of FIG. 1. Here, the user imports an input image onto a simulated canvas that includes pre-existing paint applied thereto.

FIG. 5 shows another procedure for producing artwork using the painting system of FIG. 1. Here, the user imports an input image via a paint interface provided by a painting mechanism.

FIG. 6 shows a sequence of images that may be imported by the painting system. The sequence is associated with a painting tutorial that teaches a user how to produce a painting in successive stages.

FIG. 7 is a tree that identifies different options that govern the operation of the transformation mechanism of FIG. 2.

FIG. 8 is an option selection interface that allows a user to select one or more of the options identified in FIG. 7.

FIG. 9 depicts an effect-adjustment interface that may be displayed in response to the selections made in FIG. 8.

FIG. 10 shows another option selection interface.

FIG. 11 shows another effect-adjustment interface that may be displayed in response to the selections made in FIG. 10.

FIG. 12 shows one implementation of a filter provided by the transformation mechanism of FIG. 2.

FIG. 13 depicts one manner of operation of a filter that produces a ridge-enhanced version of an input image.

FIG. 14 shows one manner of operation of a filter that produces a style-converted version of an input image.

FIG. 15 shows the operation of another filter that produces a style-converted version of an input image.

FIG. 16 shows an analysis module that provides information for use in producing a style-related filter.

FIG. 17 shows one implementation of a painting mechanism that may be used in the painting system of FIG. 1.

FIG. 18 shows a media adhesion matrix that defines a behavior that is produced when adding a new (wet) paint stroke to an existing (wet) paint stroke.

FIG. 19 shows a technique for representing wet and dry oil paint in respective wet and dry medium layers.

FIG. 20 shows a technique for modifying wet and dry oil layers in response to a drying process.

FIG. 21 illustrates a three-layer model of a simulated canvas.

FIG. 22 illustrates a manner in which a Lattice-Boltzmann Equation (LBE) technique may be applied to simulate movement of particles in a flow layer of the three-layer model of FIG. 21.

FIG. 23 illustrates a manner in which a watercolor medium may tunnel under a hydrophobic medium (such as oil paint), within the flow layer of the three-layer model of FIG. 21.

FIG. 24 shows metadata collection functionality for applying metadata collected by the transformation mechanism of FIG. 2.

FIG. 25 is a flowchart that provides an overview of one manner of operation of the painting system of FIG. 1.

FIG. 26 is a flowchart that provides an overview of one manner of operation of the transformation mechanism of FIG. 2.

FIG. 27 is a flowchart that describes one manner of operation of the filter of FIG. 12.

FIG. 28 is a flowchart that describes one manner of operation of the metadata application functionality of FIG. 24.

FIG. 29 shows illustrative computing functionality that can be used to implement any aspect of the features shown in the foregoing drawings.

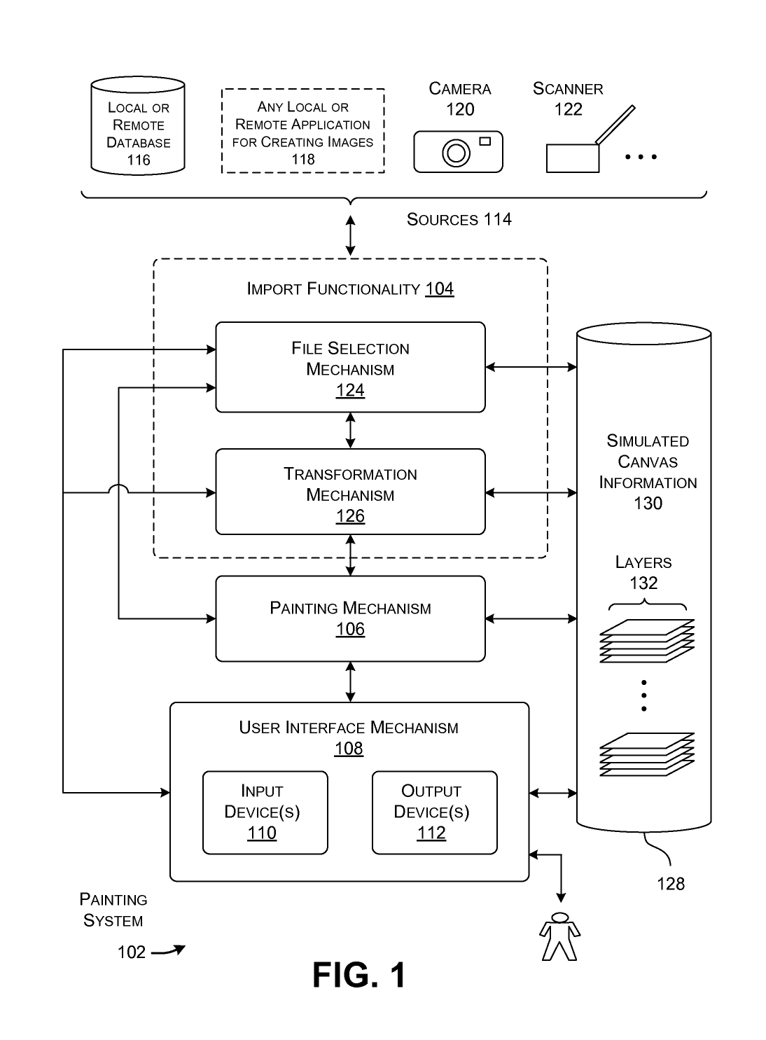

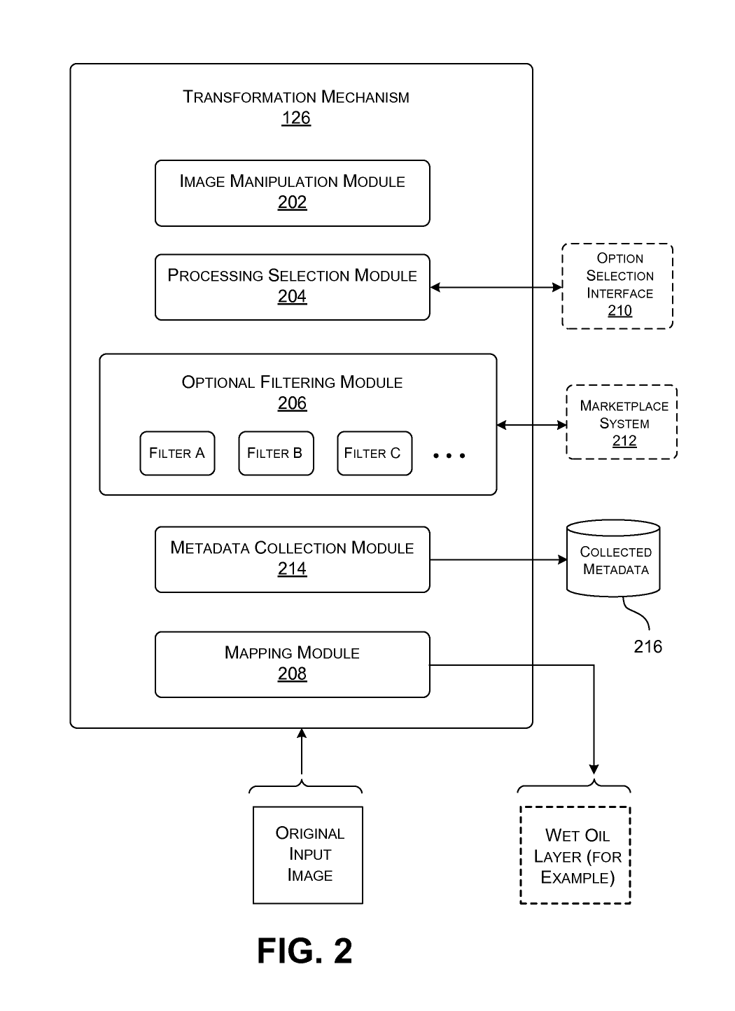

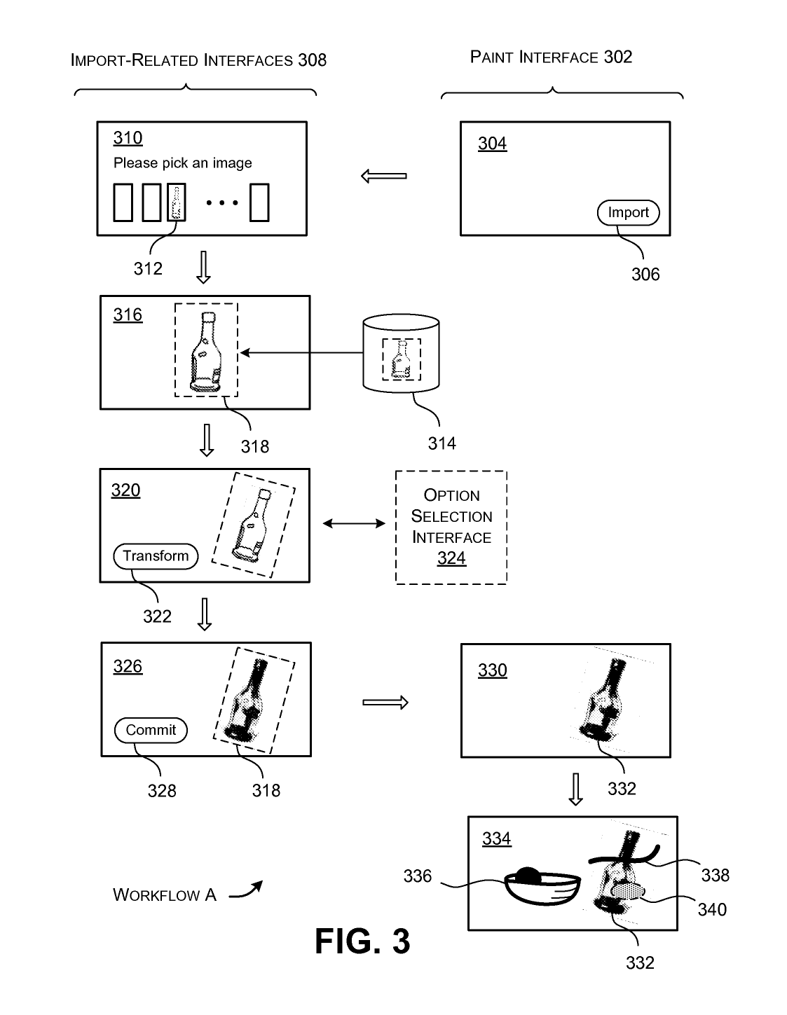

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative painting system for producing artwork based on an imported image. Section B describes an illustrative method which explains one manner of operation of the painting system of Section A. And Section C describes illustrative computing functionality that can be used to implement any aspect of the features described in Sections A and B.

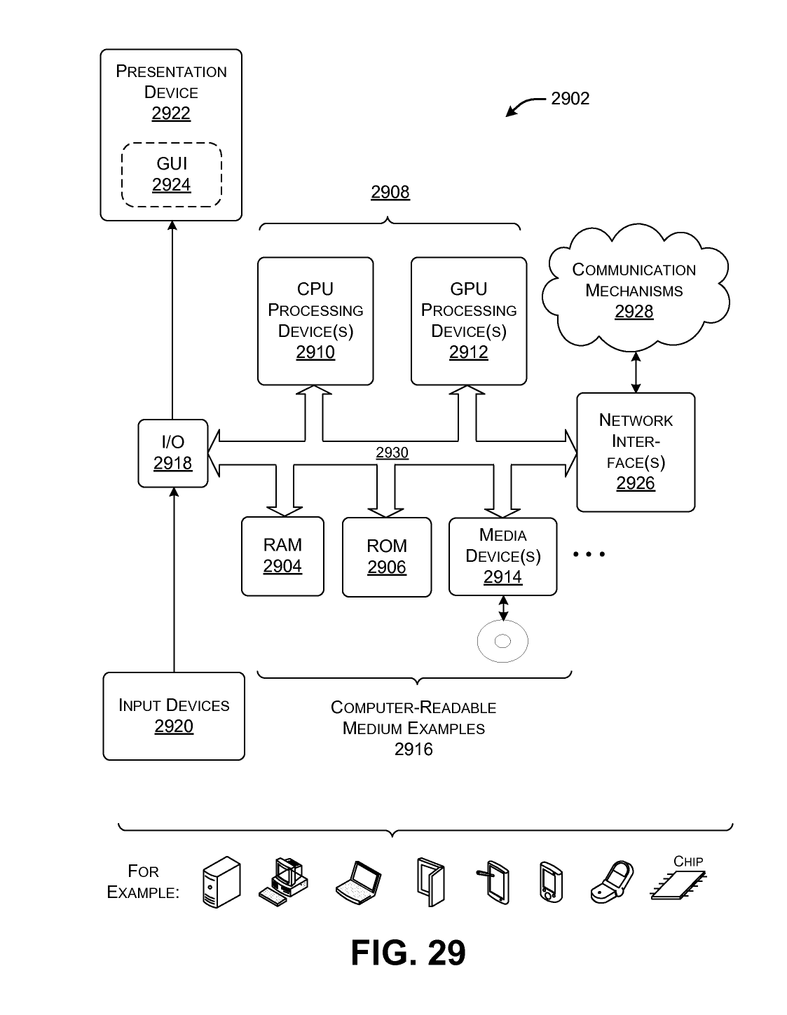

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software running on computer equipment, hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 29, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software running on computer equipment, hardware (e.g., chip-implemented logic functionality), etc., and/or any combination thereof.

As to terminology, the phrase “configured to” encompasses any way that any kind of physical and tangible functionality can be constructed to perform an identified operation. The functionality can be configured to perform an operation using, for instance, software running on computer equipment, hardware (e.g., chip-implemented logic functionality), etc., and/or any combination thereof.

The term “logic” encompasses any physical and tangible functionality for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment a logic component represents an electrical component that is a physical part of the computing system, however implemented.

The phrase “means for” in the claims, if used, is intended to invoke the provisions of 35 U.S.C. §112, sixth paragraph. No other language, other than this specific phrase, is intended to invoke the provisions of that portion of the statute.

The following explanation may identify one or more features as “optional.” This type of statement is not to be interpreted as an exhaustive indication of features that may be considered optional; that is, other features can be considered as optional, although not expressly identified in the text. Finally, the terms “exemplary” or “illustrative” refer to one implementation among potentially many implementations.

A. Illustrative Painting System

FIG. 1 shows a painting system 102 which allows a user to produce artwork based on an input image of any type. From a high-level perspective, the painting system 102 includes import functionality 104 for importing the input image, and a painting mechanism 106 for producing artwork based on the imported image. That is, the user can use the painting mechanism 106 to manipulate the image content associated with the input image as if it constituted paint that he or she manually applied to a simulated canvas, stroke by stroke. The user may prefer to produce artwork in this manner (rather than creating the artwork completely from “scratch”) to speed up the production of the artwork, and/or to overcome any creative obstacles that the user may experience in interacting with the painting mechanism 106.

A user may interact with the painting system 102 using a user interface mechanism 108. The user interface mechanism 108 may include one or more input devices 110 and one or more output devices 112. The input devices 110 can include, but are not limited to, keypad-type input devices, mouse input devices, touchscreen and touchpad input devices, joystick-type input devices, free-space gesture input devices (using camera devices to detect the free-space gestures), and so on. The interface mechanism 108 may also include one or more output devices 112. The output devices 112 can include, but are not limited to, display devices (such as LCD display devices), projectors which project content onto any surfaces, stereoscopic output devices, printers, 3D model generators, etc. In the case of a touchscreen input device, the input functionality and the output functionality are integrated into the same mechanism.

The painting system 102 can be physically implemented using any type of computing device or combination of computing devices. For example, the painting system 102 can be implemented using a personal computer, a laptop computer, a game console device, a set-top box device, a tablet-type computer, a smartphone of any type, an electronic-book reader device, and so on. In other implementations, some (or all) of the functions performed by the painting system 102 can be implemented using a remote computer, such as one or more remote servers and associated data stores. The user may interact with the remote computer(s) using any type of local computer device.

The first subsection (Subsection A.1) below provides an overview of the import functionality 104. Subsection A.2 provides illustrative details regarding filtering operations performed by the importing functionality 104. And subsection A.3 provides illustrative details regarding one illustrative painting mechanism 106 that can be used in the painting system 102.

A.1. Import Functionality

To begin with, the input image can correspond to any type of image content, expressed in any format. Further, the input image can be obtained from any source. FIG. 1 shows, without limitation, four types of sources 114 from which the input image may be obtained. In one case, a user may access the input image from a local database or a remote database 116. A local database refers to a storage mechanism that is local with respect to the import functionality 104 and the painting mechanism 106, while a remote database refers to a storage mechanism that is remotely located with respect to the import functionality 104 and painting mechanism 106. For example, a remote database may represent a storage mechanism that a user may access via a wide area network (e.g., the Internet).

In another case, the user may receive the input image from any local or remote application 118 that produces image content. Illustrative types of applications include painting applications, other painting and drawing applications, photo editing applications, etc. The application may be local or remote in the same sense described above. For example, the user may access the input image from a remotely-implemented social networking application.

In another case, the user may provide the input image via a camera device 120 of any type. Illustrative camera devices include image-forming mechanisms which produce static image snapshots, and/or video content, and/or three-dimensional content (either static or moving), and so on. The camera device 120 can produce three-dimensional content using any depth-determination technique, such as a time-of-flight technique, a stereoscopic technique, a structured light technique, etc. One commercial system for producing depth images is the Kinect™ system produced by Microsoft® Corporation of Redmond, Wash.

In one case, the camera device 120 may correspond to an image-forming mechanism that is integrated with whatever device implements the import functionality 104 and the painting mechanism 106. In another case, the camera device 120 may correspond to an image-forming mechanism that is physically separate from the import functionality 104 and the painting mechanism 106.

In another case, the user may provide the input image using a scanning device 122 of any type. The above sources 114 of image content are cited by way of example, not limitation.

The import functionality 104 may include a file selection mechanism 124 by which the user may select the input image. In one case, a user invokes the file selection mechanism 124 by activating an import control button or the like, e.g., in the context of interacting with the painting mechanism 106, or in some other context. In response, the file selection mechanism 124 presents a file selection interface. In one case, the import functionality 104 may implement its own file selection interface. In another case, the import functionality 104 may leverage a third-party file-picking application to implement the file selection interface.

In one case, the file selection interface may provide a listing of available images. The user may then select one of these images, which causes this image to be supplied to the import functionality 104. Or the file selection interface may correspond to an image-capture interface provided by the camera device 120. The user may interact with the camera device 120 via this interface to capture a digital photograph and provide it into the import functionality 104. Still other implementations of the file selection interface are possible.

A transformation mechanism 126 provides functionality which allows a user to process the input image in any manner (to be described below). For example, the user may use the transformation mechanism 126 to move, rotate, or resize the input image. The user may also apply one or more filters to the input image using the transformation mechanism 126, to produce a transformed image.

A data store 128 stores simulated canvas information 130. The simulated canvas information represents a simulated canvas, or, in other words, simulated paint that is applied to a simulated canvas substrate. The simulated canvas information 130 may include various parts, such as various layers 132, corresponding to different media-related aspects of the simulated canvas. A subset of the layers 132, for instance, may describe the characteristics of the canvas substrate on which the user may paint. Another subset of the layers 132 may describe the media that the user may apply to the canvas substrate. For instance, the simulated canvas information may devote one or more layers to each of an oil medium, a watercolor medium, a pastel medium, a graphite medium, a wax medium, and so on. These types of media are cited by way of example, not limitation. To facilitate and simplify the description, any type of medium is referred to herein as a form of paint. Hence, even a graphite medium is referred to herein as a form of paint.

The simulated canvas information 130 can also maintain information which indicates the order in which the user has applied paint strokes to the simulated canvas. Hence, the simulated canvas information 130 maintains information regarding the layering of different kinds of paint on the canvas substrate. Moreover, the painting mechanism 106 provides rules (to be described below) which indicate how each layer of paint may interact with its underlying layer(s) of paint (if any). The painting mechanism 106 determines the visual appearance of the simulated canvas at any given time, and at any given position, by determining the layering of paint applied at that position, and the manner in which the different kinds of paint interact with each other at that position. In one representative case, for instance, a top-most layer of oil paint may completely cover up any underlying layers of paint (if any).

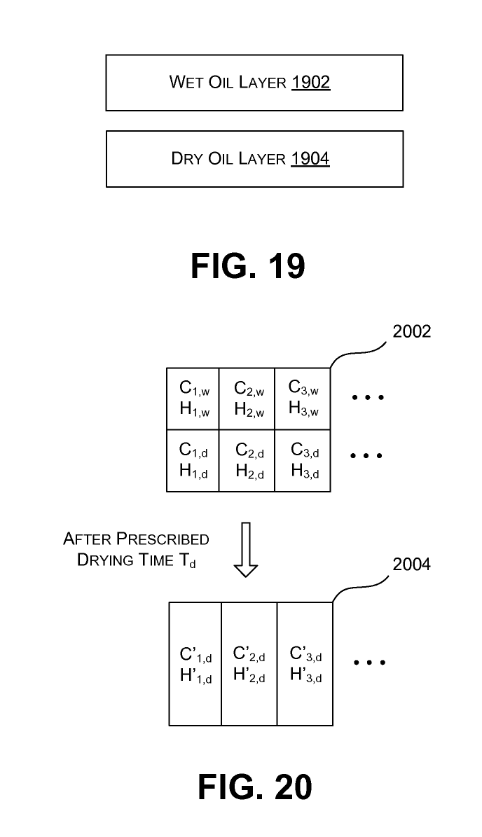

Different implementations of the painting mechanism 106 can use different data structures to represent the parts of the simulated canvas information 130. For example, the painting mechanism 106 can represent each layer as a separate array of values, or as a field within an array, or by any other data structure. Moreover, the painting mechanism 106 can consolidate two or more underlying layers into a single representative layer in various circumstances. For example, assume that the user applies wet oil paint over dry oil paint. Once the wet oil paint is considered to have dried, the painting mechanism 106 can use a single layer to represent the dry oil paint (as will be described more fully with reference to FIGS. 19 and 20).

The transformation mechanism 126 operates by adding new paint information to the simulated canvas information 130. The new paint information may correspond to the image content provided in the original input image, or image content provided in a transformed image (which is produced by transforming the original input image using one or more filters), or both the original image and the transformed image. Metaphorically, in performing this operation, the transformation mechanism adds new paint to a simulated canvas, where that new paint is directly or indirectly obtained from the input image.

For example, assume that a user indicates that the original input image is to be interpreted as constituting wet oil paint (although, as stated above, the input image can take any original form, such as a digital photograph, and may not have any “innate” affiliation with any medium). In response, the transformation mechanism 126 can map the color values in the original input image into the layer (or layers) of the simulated canvas information 130 that are associated with wet oil paint. In another case, assume that the user indicates that the original input image constitutes wet watercolor paint. In response, the transformation mechanism 126 can map the color values in the original input image into the layer (or layers) of the simulated canvas information 130 that are associated with wet watercolor paint. As will be described below, the transformation mechanism 126 can also map height values to the simulated canvas information 130. The height values represent the height (e.g., thickness) of the new paint on the simulated canvas surface.

At this juncture, the user may use the painting mechanism 106 to modify the simulated canvas information 130 in any manner. For example, the user may use the painting mechanism 106 to apply additional paint strokes to the simulated canvas. Alternatively, or in addition, the user may use the painting mechanism 106 to modify the new paint added by the transformation mechanism 126, without otherwise applying additional paint to the simulated canvas. For example, the user may use the painting mechanism 106 to smear or smudge the wet paint that is derived from the input image. In summary, the user may interact with the new paint associated with the input image in the same manner as any other paint strokes that are applied to the simulated canvas in a manual manner.

FIG. 2 shows further details regarding one implementation of the transformation mechanism 126. The transformation mechanism 126 includes various modules for operating on an input image, including an image manipulation module 202, a processing selection module 204, a filtering module 206, a mapping module 208, and a metadata collection module 214.

The image manipulation module 202 provides a mechanism by which a user may manipulate the placement of the input image (and/or the transformed image), to provide placement information. The user may perform this manipulation within an import interface provided by the import functionality 104 or a paint interface provided by the painting mechanism 106, or in some other context. In one implementation, the user can use the image manipulation module 202 to perform any affine transformation(s) on the input image (and/or the transformed image produced by the filtering module 206). For example, the user may use the image manipulation module 202 to modify the position of the input image within a manipulation space. Alternatively, or in addition, the user may use the image manipulation module 202 to modify the orientation of the input image within the manipulation space. Alternatively, or in addition, the user may use the image manipulation module 202 to change the size of the input image. Further, the user may use the image manipulation module 202 to crop and/or warp the input image in any manner. The user can also interact with the image manipulation module 202 to perform a panning operation within the input image.

Further, the user may import three-dimensional image content, e.g., representing one or more objects in a three-dimensional space. Here, the user may use the image manipulation module 202 to manipulate any part of the input image in three dimensions. For example, a user could use the image manipulation module 202 to flip an object over and subsequently paint on its back surface, or any other surface that is not initially visible.

The processing selection module 204 allows a user to specify the manner in which the input image is to be processed by the transformation mechanism 126. For example, the user may use the processing selection module 204 to identify the type(s) of medium (or media) that are to be associated with the input image, such as oil, watercolor, etc. The user may also use the processing selection module 204 to identify the state of each medium, such as by indicating whether the paint is wet or dry. The user may also use the processing selection module 204 to identify additional filtering operations to be applied to the input image, if any. In one implementation, the user may select these options within an option selection interface 210.

The filtering module 206 may include one or more filters (e.g., filter A, filter B, filter C, etc.). Each filter may perform a different type of transformation on the input image, to produce a transformed image. Illustrative types of filters will be described below. The filtering module 206 can also transform the input image by applying two or more filters to the input image, e.g., in series or in any other configuration. The collection of filters applied by the filtering module 206 is fully configurable and extensible.

In one implementation, for instance, a marketplace system 212 may offer different types of available filters from which the user may select. A user can obtain any filter of interest from the marketplace system 212 based on any business paradigm. For instance, the marketplace system 212 can offer the filters free of charge. Alternatively, or in addition, the marketplace system 212 can provide the filters to the user on a subscription basis, a per-item fee basis, or on the basis on any other business strategy.

The mapping module 208 adds new paint information to one or more appropriate layers of the simulated canvas information. More specifically, in some cases, the user indicates that the input image (or its transformed counterpart image) constitutes image content associated with a single medium. In that situation, the mapping module 208 may map the color values in the input image (or its transformed counterpart image) into the layer or layers associated with that single medium. In other cases, the user indicates that the input image (or its transformed counterpart image) constitutes image content associated with two or more kinds of media. For example, the user may specify that the edges in the input image are to be represented by a graphite medium, while the entirety of the input image is to be represented by a watercolor medium. In that situation, the mapping module 208 may map the color values in the input image (or its transformed counterpart image) into the layers associated with two different kinds of media, graphite and watercolor.

More specifically, consider the case in which an input image (or its transformed counterpart image) comprises a two-dimensional array of color values expressed in any format and in any color scheme (such as an RGB color scheme). Further assume that the input image (or its transformed counterpart image) is being interpreted as wet oil paint. The mapping module 208 may map RGB values provided in the input image (or its transformed counterpart image) into appropriate positions in the wet oil layer of the simulated canvas information 130. The bottom portion of FIG. 2 illustrates this mapping operation. The mapping module 208 can also perform interpolation when performing this mapping operation, e.g., to address those situations when the size of the input image (or its transformed counterpart image) differs from the size of the wet oil layer.

The mapping module 208 can also map other information into the simulated canvas information 130 that pertains to the new paint. For example, in addition to color values, the mapping module 208 can add depth values to the appropriate layer(s) of the simulated canvas information 130. These depth values reflect the height profile of the paint in the simulated canvas—that is, the thickness of the paint on the simulated canvas.

In a first case, the user may indicate that the paint has a flat profile. This selection indicates that that all of depth values across the input image are the same. For example, the depth values for a flat image may all be given a height of zero. In a second case, the user may indicate that the paint has a ridged profile. This selection indicates that the depth values may vary across the input image to simulate ridges produced by a paint brush as it moves across the simulated canvas. More specifically, this effect simulates the ridges produced by the bush as it pushes wet paint to one or more sides of its path as it moves across the simulated canvas, and/or as it pushes paint between its bristles. One or more filters provided by the filtering module 206 may produce this ridge effect (to be described below). The mapping module 208 can supply yet additional supplemental information (besides color values and height values) to the simulated canvas information 130.

In the above explanation, for simplicity, it was assumed that the import functionality 104 operates on a single input image at any given time. It was further assumed that the import functionality 104 provides a single image to the paint mechanism. But in some cases, the import functionality 104 can operate on plural images at any given time, and import the plural images (as a group) into the paint mechanism 106. For example, the user may invoke this feature to produce a collage-type painting, made up of content derived from two or more input images.

The transformation mechanism 126 may also include a metadata collection module 214 for collecting metadata that pertains to the input image, and for storing the metadata in a data store 216. The metadata collection module 214 can use different techniques to collect any type of metadata. In one case, the metadata collection module 214 forms a histogram of color values that appear within the original input image and/or the transformed image produced by the filter module 206. The metadata collection module 214 may then store the entire histogram in the data store 216, or just an indication of the prominent colors within the histogram.

In addition, or alternatively, the metadata collection module 214 can perform image analysis on the input image (and/or the transformed image) to generate information regarding its spatial characteristics. For example, the metadata collection module 214 can perform image analysis to determine an average thickness of strokes (e.g., lines) in the image(s), an average density of strokes in the image(s), an average amount of detail in the image(s), and so on.

In addition, or alternatively, the metadata collection module 214 can store filter parameters pertaining to any filter(s) that were applied by the filtering module 206. In some cases, the user may manually select these parameters. For example, the user may explicitly select a filter setting that defines a width of graphite strokes in the transformed image. In other cases, the filtering module 206 may automatically apply these parameters, without input from the user. These kinds of metadata are cited by way of illustration, not limitation.

FIGS. 3-6 show various different workflows by which the user may interact with the import functionality 104 and the painting mechanism 106. Starting with FIG. 3, assume that the user begins the process of creating a simulated painting by invoking a paint interface 302 provided by the painting mechanism 106. At state 304, assume that the paint interface 302 provide a blank simulated canvas. At this juncture, the user may select an import control button 306 (or the like) to commence the import process. Activation of the import control button 306 prompts the import functionality 104 to provide a series of import-related interfaces 308.

First, at state 310, the file selection mechanism 124 provides a file selection interface that enables the user to select the input image from any source, or to capture the input image using the camera device 120. Assume that the user selects an input image 312 that corresponds to a digital photograph of a bottle. Further assume that the file selection mechanism 124 retrieves the input image from a local or remote database 314.

At state 316, the transformation mechanism 126 displays a depiction of the input image 312 within a manipulation window 318. The user may then use the image manipulation module 202 to manipulate the input image 312 in any manner. For example, the user may move the input image 312 to a new location within a manipulation space provided by the import-related interfaces 308. Alternatively, or in addition, the user may change the orientation of the input image 312, or resize the input image 312.

More specifically, the user can change the position of the input image 312 by using any input device to drag the manipulation window 318 across the manipulation space. Illustrative input devices include a touchscreen (with which a user may engage using a finger, etc.), a mouse device, a keypad, etc. The user may rotate the input image 312 by using any input device to select a corner of the manipulation window 318 and then rotate it in a clockwise or counterclockwise direction within the manipulation space. The use may resize the input image 312 by using any input device to grasp a peripheral region of the manipulation window 318 and drag it outward or inward (to respectively increase or decrease the size of the input image 312). Assume that, in the specific scenario shown in FIG. 3, that the user rotates the input image 312. State 320 shows the outcome of this rotation operation.

At state 320, assume that the user is satisfied with the placement of the input image 312. At this juncture, the user may activate a transform control command 322. This action prompts the transformation mechanism 126 to display an option selection interface 324. The option selection interface 324, in turn, allows a user to specify the manner in which the image content in the input image 312 is to be processed. In this case, assume that the user uses the option selection interface 324 to specify that the input image is to be interpreted as wet oil paint having a textured (e.g., ridged) height profile. In response, the transformation mechanism 126 can apply an appropriate filter which produces ridges across the surface of the input image, which simulate ridges produced by a brush.

State 326 shows a transformed image within the manipulation window 318, representing the outcome of the filtering operation described above. Although not shown, the user can manipulate the transformed image using the image manipulation module 202 in any manner described above, such as by rotating the transformed image and/or changing the position of the transformed image, etc. In other words, the user can invoke the image manipulation module 202 at any stage in the workflow process.

At this stage, assume that that the user is satisfied with the transformed image and desires to formally import it into the painting mechanism 106. To perform this task, the user may activate a commit control command 328. This operation prompts the transformation mechanism 126 to map the color and depth values associated with the transformed image into the appropriate layer(s) of the simulated canvas information 130. This operation corresponds to adding new paint information to the simulated canvas information 130, which may be metaphorically viewed as adding new paint to the blank simulated canvas.

At state 330, the paint interface 302 shows image content 332 that corresponds to the new paint that has been imported onto the blank simulated canvas. As this stage, the user may modify the artwork in any manner. For example, at state 334, the user has painted a bowl 336 next to the imported image content 332. The user can also add any new paint strokes over the image content 332 itself (such as illustrative new paint stroke 338). The oil paint associated with the imported image content 332 is also defined as being wet at this time. This condition means that the user can also modify this new paint in any manner, such as smearing or smudging this new paint (as indicated by the illustrative paint smudge 340). In some cases, the act of smearing and smudging can more clearly reveal the texture of the underlying simulated canvas (if the canvas, in fact, is assigned a texture profile having variable height), particularly in those cases in which the new paint is initially imported as a flat image.

The interface presentations and control mechanisms described above are set forth by way of illustration, not limitation. Other implementations can vary the above-described interface presentations and control mechanisms in any manner, and/or the order in which the interface presentations and control mechanisms are provided.

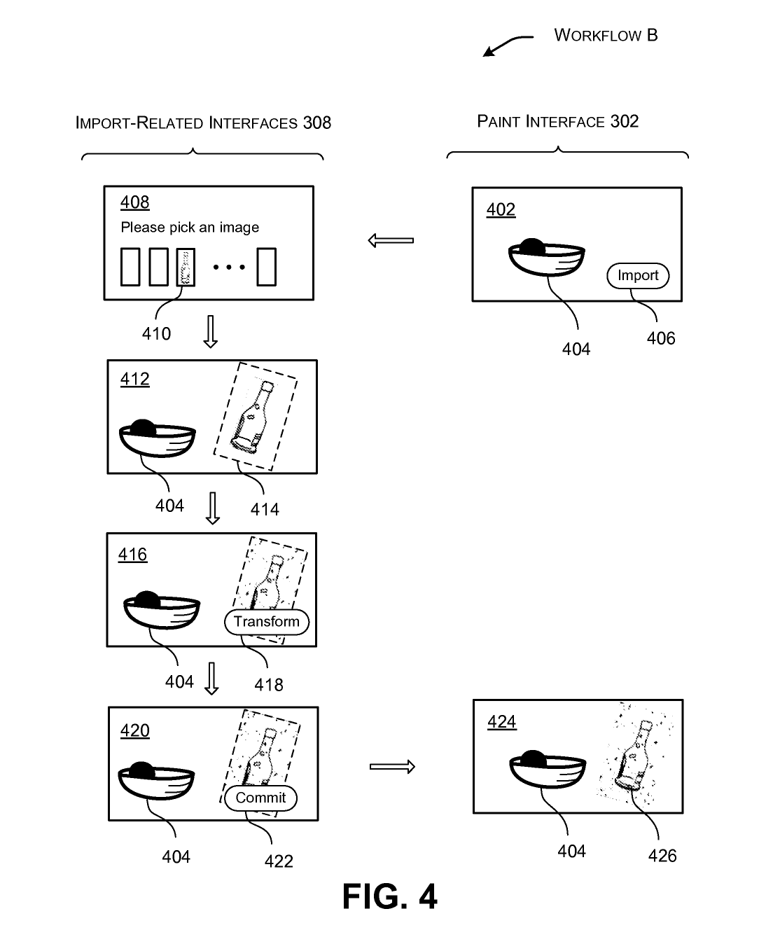

FIG. 4 presents another workflow by which the user produces artwork based on an imported image. In this case, however, the user does not start with a blank canvas. Rather, at state 402, assume that the user has already painted a picture of a bowl 404 using any medium, such as simulated oil paint. Assume that the user next wishes to import a photograph of a bottle to add to his or her painting. For example, assume that the user wishes to import the photograph as a wet watercolor image.

To perform the above task, the user can activate an import control button 406 within the paint interface 302. This operation prompts the transformation mechanism 126 to display, at state 408, a file section interface. Assume that the user again selects an input image 410 corresponding to a picture of a bottle.

At state 412, the transformation mechanism 126 displays the input image 410 within a manipulation window 414. The transformation mechanism 126 may also optionally display a depiction of the bowl 404, which is exported from the painting mechanism 106. At this juncture, assume that the user rotates the manipulation window 414 to a desired orientation within a manipulation space, thus rotating the associated input image 410.

At state 416, the user activates a transform control command 418, which prompts the transformation mechanism 126 to display an option selection interface (not shown). Assume that the user specifies, via the option selection interface, that the input image 410 is to be interpreted as a wet watercolor image. The user may also optionally specify that the outline of the image content in the input image 312 is to be represented using a graphite medium. To accomplish this latter objective, the transformation mechanism 126 can apply one or more filters to identify the edges in the image content in the input image 410.

In state 420, the user may activate a commit control command 422 to import the input image and the transformed image as new paint onto the simulated canvas. For example, the transformation mechanism 126 can map the color values in the original input image 410 into one or more watercolor layers of the simulated canvas information 130. Further, the transformation mechanism 126 can map color values in the edge-enhanced version of the input image into one or more graphite layers of the simulated canvas information 130.

At state 424, the paint interface 302 presents a depiction of the current state of the artwork being created. The artwork includes the previously created picture of the bowl 404, painted using simulated oil paint. The artwork also includes image content 426, corresponding to a watercolor picture of a bottle. At this juncture, the user may modify the artwork in any manner, e.g., by adding new paint strokes to the artwork, by adding additional water to the image content 426, and so on.

Further note that the image content 426 has been imported as a wet watercolor medium. As will be explained below in greater detail, the painting mechanism 106 can simulate the absorption of the watercolor paint into the simulated canvas, and the lateral dispersion of the watercolor paint within the simulated canvas. Hence, after importing the image content 426, the image content 426 may continue to dynamically change its appearance until its pigments become stable within a fixture layer of the simulated canvas (to be described below in greater detail). In an alternative implementation, the painting system 102 can simulate the dynamic dispersion of the watercolor paint within the import-related interfaces 308, prior to adding the image content 426 to the paint interface 302. More generally stated, the painting system 102 can simulate the dynamic dispersion of a watercolor medium within the simulated canvas over a span of time, after the watercolor medium has been applied.

Although not shown, it is also possible to import image content over existing paint on the simulated canvas. The painting mechanism 106 interprets the new paint as if the user had manually added new paint strokes over the top of the exiting paint strokes. The painting mechanism 106 maintains rules (to be described below) which describe how a top-level paint will interact with a bottom-layer paint (if at all). Depending on the user's selection, the new paint can be interpreted as wet paint, or dry paint, or some combination of wet paint and dry paint.

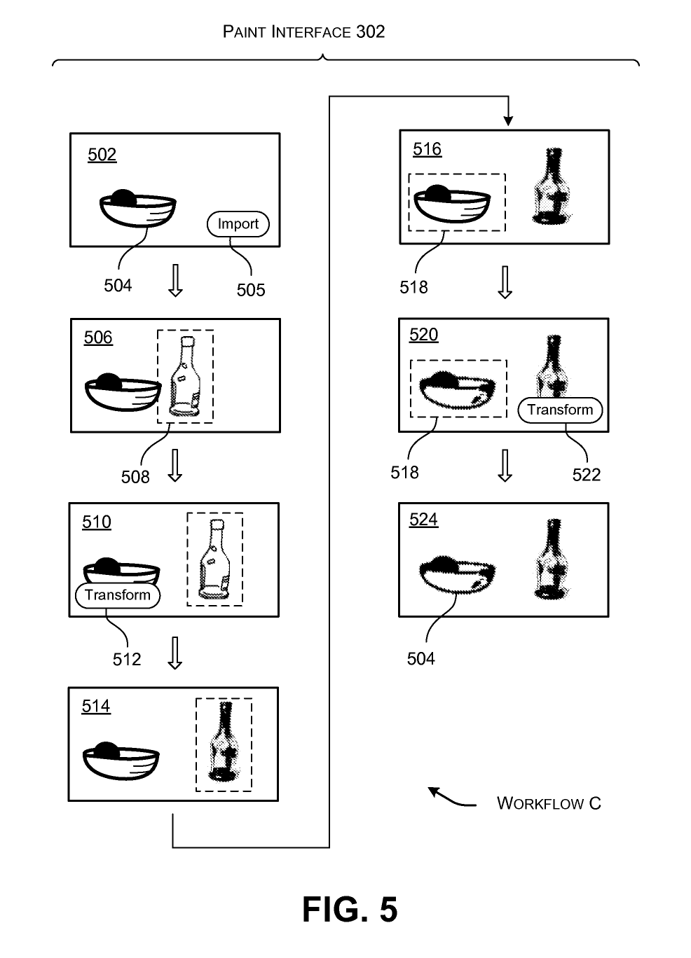

FIG. 5 shows another workflow for producing artwork based on an imported image. In this scenario, the user interacts with the import functionality 104 in the context of the paint interface 302 provided by the painting mechanism 106, rather than via separate import-related interfaces 308.

At state 502, the user draws a picture of a bowl 504 in a graphite medium, and then selects an import control command 505. This action prompts the transformation mechanism 126 to provide a file selection interface (not shown), by which the user may select an input image that depicts a bottle. At state 506, the transformation mechanism 126 displays a depiction of the input image within a manipulation window 508. At state 510, the user manipulates the position of the input image by shifting the manipulation window 508 to the right. The user then activates a transform control command 512, which invokes an option selection interface (not shown). The user may interact with the option selection interface to specify that the input image is to be interpreted as a wet oil painting having a ridged texture. This action prompts the transformation mechanism 126 to map color and height values associated with the transformed image into one or more appropriate layers of the simulated canvas information 130. State 514 represents the outcome of this operation.

In state 516, now assume that the user wishes to assign a new medium to the picture of the bowl 504. The user can perform this task in any manner, such as by using a finger or mouse device (or any other input technique) to designate a selection window 518 that encloses the bowl 504. In state 520, the user selects a transform control command 522, which prompts the transformation mechanism 126 to display an option selection interface (not shown). The user may interact with the option selection interface to assign a new medium to the picture of the bowl 504. For instance, as stated, the user has originally drawn the bowl 504 using a graphite medium. The user may now designate that the paint associated with the bowl 504 is to be considered as a wet oil medium. The transformation mechanism 126 can carry out this reassignment by transferring the color values associated with the graphite layer(s) of the simulated canvas information 130 to the color values associated with the wet oil layer(s) of the simulated canvas information 130. The transformation mechanism 126 can also map height values to the appropriate layer(s) to indicate whether the converted image content has a flat or ridged profile.

State 524 reflects the outcome of the transformation described above. At this juncture, the artwork consists of a depiction of a bowl 504 next to an imported picture of bottle, both represented in wet oil at this time. The user can manipulate this image content in any manner, such as by adding new paint strokes to the artwork, and/or by smudging or smearing the existing oil paint on the simulated canvas.

The broader point being conveyed by FIGS. 4 and 5 is that the user can invoke the operations of the import functionality 104 at any stage in producing the artwork. That is, the user is not limited to invoking these operations at the outset of a painting task (as is the case of FIG. 3), starting with a blank canvas. Further, the user can apply the operations of the import functionality 104 to any image content, even image content that the user creates using the painting mechanism 106 itself (as indicated in the example of FIG. 5).

In the above description, it was assumed that the input image corresponds to a single static snapshot that has been previously captured, or captured in response to the user's contemporaneous interaction with the camera device 120. In another case, the user can import a sequence of input images. In a first scenario, for example, a user may select a previously captured video snippet, or may contemporaneously capture a video snippet using the camera device 120. Each frame in the video snippet constitutes an input image. The transformation mechanism 126 can then allow a user to select any processing options, such as a type of medium (or plural media) to be associated with the input images. In addition, the user can select any filtering operations to be performed on the input images, using the filtering module 206. The transformation mechanism 126 can then apply the designated processing operations to each input image in the sequence of images. This operation may yield, for example, visual content that resembles a dynamically changing oil painting.

In another case, the transformation mechanism 126 can transform the input images in the sequence of input images in a dynamic manner, that is, as the user is capturing the input images using the camera device 120 (or as the user is otherwise receiving the input images from any source). The painting system 102 can also dynamically show the results of the transformation as the user captures or otherwise receives the input images. The painting system 102 can perform this operation in different scenarios. In a first case, the user may manipulate the camera device 120 for the purpose of producing and storing a video snippet. In a second case, the user may manipulate the camera device 120 for the purpose of creating a static snapshot; here, the painting system 102 will capture and transform the input images on a dynamic basis up to and including the time at which the user presses a “take photo” command. Prior to that command, the user may move the camera device 120 in any manner; further, the scene that is captured by the camera device 120 may change in any manner. In any of the above cases, the camera device 120 may represent a standalone device, or may represent camera functionality that is integrated into another device (such as a smartphone, tablet-type computer device, etc.).

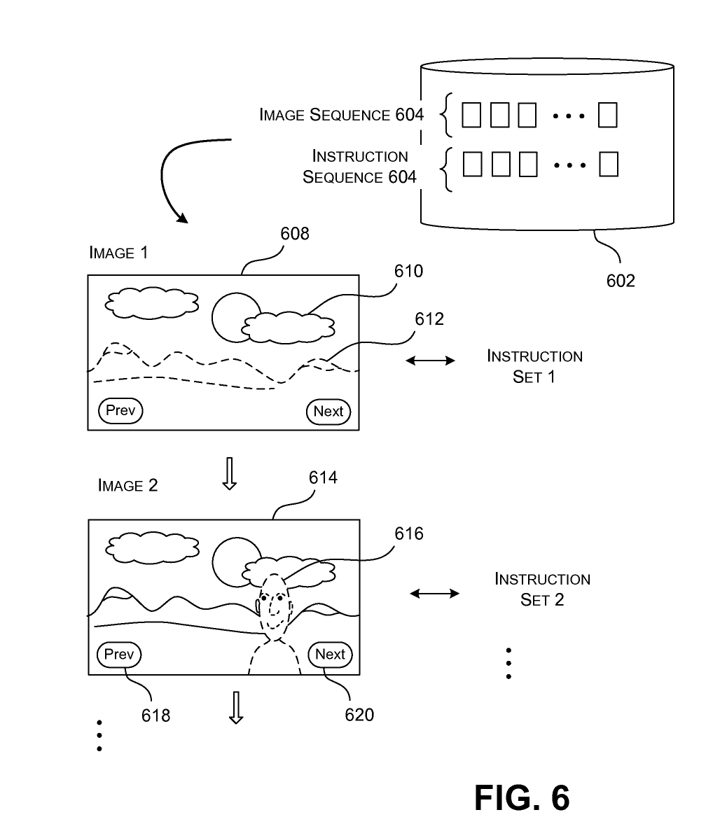

Advancing to FIG. 6, this figure shows a data store 602 that stores at least one painting tutorial. The painting tutorial includes a sequence of images 604 and an associated sequence of instructions 606. Each image in the sequence of images 604 presents a visual depiction of an artwork at a particular stage in the development of that artwork. Each image has a corresponding instruction set. The instruction set explains to the user how he or she may modify the artwork, at the current stage in the development of the artwork.

For instance, assume that the user chooses a first input image 608 in the sequence of images 604. The first input image 608 shows the background content 610 of the artwork, e.g., depicting the sky-related portions of the artwork. The first input image 608 also shows an outline 612 of subsequent content that the user may add to the artwork, corresponding to a depiction of distant mountains. The painting system 102 may also provide a first instruction set to the user. The first instruction set provides assistance to the user in modifying the artwork, in its present state. For example, the first instruction set may advise the user to add strokes in a particular manner to create the mountain portion of the artwork. The first instruction set may also advise the user to use certain colors in painting the mountains.

The painting system 102 can present the instruction set in any manner. For example, the painting system 102 can display the instruction set in the margin of the painting interface (not shown), or in a separate pop-up window (not shown), or in some other manner. Alternatively, or in addition, the painting system 102 can present the instructions in audible form, e.g., as spoken instructions.

A second input image 614 corresponds to a next image in the sequence of images 604. At this juncture, the second input image 614 presents a now-completed depiction of the background. The second input image 614 also depicts a human subject 616 in outline form in the foreground of the artwork. The painting system 102 presents a second set of instructions that assist the user in painting the foreground subject.

A user may choose to interact with the kind of painting tutorials described above in different ways. In one case, the user may import a particular image in the sequence of images 604, corresponding to a particular stage in the development of an artwork. The user may then practice the painting exercises that pertain to this stage. The user may then choose to complete the artwork at this point. Alternatively, the user may activate another image in the sequence of images 604. This action may prompt the painting system 102 to optionally erase the user's previous contribution to the painting. The painting system 102 may then present a new input image and a corresponding new instruction set. In one case, a user may advance through the sequence of images 604 in the above-described manner using navigation control buttons, such as previous and next controls buttons (618, 620).

In a second implementation, each image in the sequence of images includes an incremental addition to the content of the preceding image (if any). For example, for the second input image 614, instead of presenting both the background and the foreground content, the second input image 614 may present just the outline of the human subject 616. The painting system 102 may overlay this second input image 614 on the current state of the user's painting. In this manner, a user can call up a next image without the user's prior contribution to the artwork interfering with the next image. Hence, in this implementation, the painting system 102 need not erase the user's contribution upon advancing to the next image.

At any stage, the user may also interact with the transformation mechanism 126 to specify the manner in which the image content in the input image is to be interpreted. For example, the user can specify that the input image is to be interpreted as a wet painting (formed by any medium or combination of different kinds of media), or a dry painting (formed by any medium or combination of different kinds of media), or a combination of wet and dry paint. In the case of a wet painting, the user may be able to subsequently interact with the wet paint. In the case of a dry painting, the user may be precluded from interacting with the dry paint. The user may also specify any optional filters to be applied to the image. For example, the user may indicate that an image corresponds to a watercolor picture in a wet state. Further, the painting system 102 can vary the content of the instructions that it presents to the user based on the processing option selections that the user makes via the transformation mechanism 126. For example, the painting system 102 can present a first set of instructions if the user designates the input image as a watercolor image, and a second set of instructions if the user designates the input image as an oil image.

In a third implementation, the import functionality 104 can import each image in the sequence of images 604 as a background image that lies “behind” the surface of the simulated canvas. In this implementation, the background image does not constitute paint with which the user may interact or affect. In the third implementation, like the second implementation described above, there is no need to erase the user's contribution to the painting as the user advances from one stage to the next; the user is always painting on top of the background image. In another case, the import functionality 104 can import each input image as image content which will appear as an overlay, that is, on top of any painting strokes that the user will subsequently add to the simulated canvas. In one optional implementation, the overlay image may represent content with which the user may be precluded from interacting.

In summary, the scenario shown in FIG. 5 provides two levels of assistance to the user. First, it imports pre-generated image content into the painting mechanism 106 in the manner described above. Second, this scenario provides instructions which guide the user in modifying the simulated canvas after the image content has been imported.

In one implementation, a marketplace system (not shown) may offer various painting tutorials of the type described above. A user can select and download any painting tutorial based on any business paradigm. For instance, the marketplace system can offer the painting tutorials free of charge. Or the marketplace system can provide the painting tutorials to the user on a subscription basis, a per-item fee basis, or based on any other business strategy.

A.2. Illustrative Filtering Module

Advancing now to FIG. 7, this figure identifies different options that a user may select via the processing selection module 204. In a first category of options, the processing selection module 204 can assign a type of medium (or plural media) to the paint in the input image, based on the user's selection(s). Without limitation, illustrative types of media include an oil medium, a watercolor medium, a graphite medium, a pastel medium, a wax medium, etc.

The selection of a type of medium may or may not invoke the application of a particular filter. For example, assume that the user indicates that the image content in a digital photograph corresponds to flat oil paint. The transformation mechanism 126 can directly map the RGB values in this input image into the appropriate layer(s) of the simulated canvas information 130, without applying any type of filter to the input image. In another case, assume that the user indicates that the image content corresponds to a graphite drawing. Here, the transformation mechanism 126 may optionally apply a filter to the input image which simulates cross-hatching, prior to mapping the resultant color values into the appropriate layer(s) of the simulated canvas information.

In a second category of options, the processing selection module 204 can identify the state associated with each medium, based on the selection(s) of the user. Illustrative states include a dry state and a wet state. Paint in a dry state is considered dry, which means that, in one implementation, it can longer interact with later-added wet paint. Paint in a wet state is considered not yet dry, which means that it can potentially interact with later-added wet paint. The specification of a state of a medium may or may not invoke the application of a particular filter, depending on the particular circumstance.

In a third category of options, the processing selection module 204 can identify one or more supplemental effects that may be applied to the input image, based on the user's selection(s). In one technique, a filter can detect edges in the input image to provide an edge-enhanced version of the input image. In another technique, a filter can form a color-faded version of the input image. In some cases, the color-faded version of the input image may be opaque, such that it completely obscures underlying paint strokes (if any) when the input image is placed over these paint strokes. In other cases, the color-faded version of the image may be semi-transparent, such that it reveals, to some extent, underlying paint strokes (if any). In a third technique, a filter can add ridges to paint in the input image, simulating ridges that would be produced by brush strokes. These supplemental effects are cited by way of example, not limitation.

In a fourth category of options, different types of filters can transform the input image so that it conforms to different respective general styles, based on the user's selection(s). Illustrative types of general styles include, but are not limited to: Middle Ages, Renaissance, Baroque, Impressionism, Symbolism, Surrealism, Dada, Abstract Expressionism, Realism, Pop Art, and so on.

In a fifth category of options, different types of filters can transform the input image so that it conforms to different styles associated with respective artists, based on the user's selection(s). Illustrative types of artist-specific styles include, but are not limited to: Di Vinci, Rembrandt, Monet, Renoir, Van Gogh, Gauguin, Picasso, Dali, Mondrian, Lichtenstein, Warhol, Pollock, and so on.

The processing selection module 204 can allow a user to choose among yet further categories of options. The above categories are cited above by way of example, not limitation.

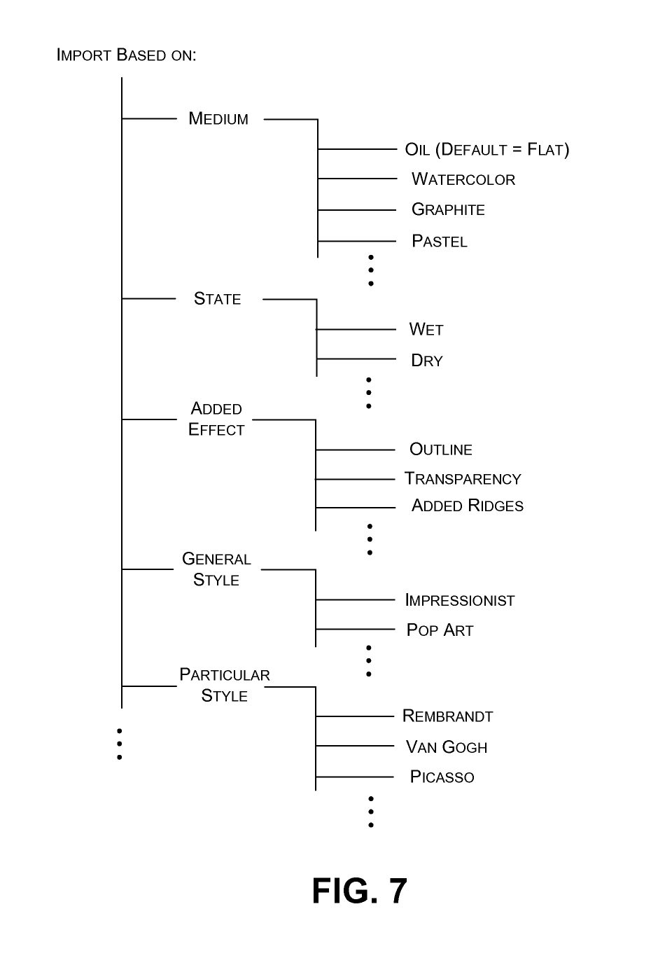

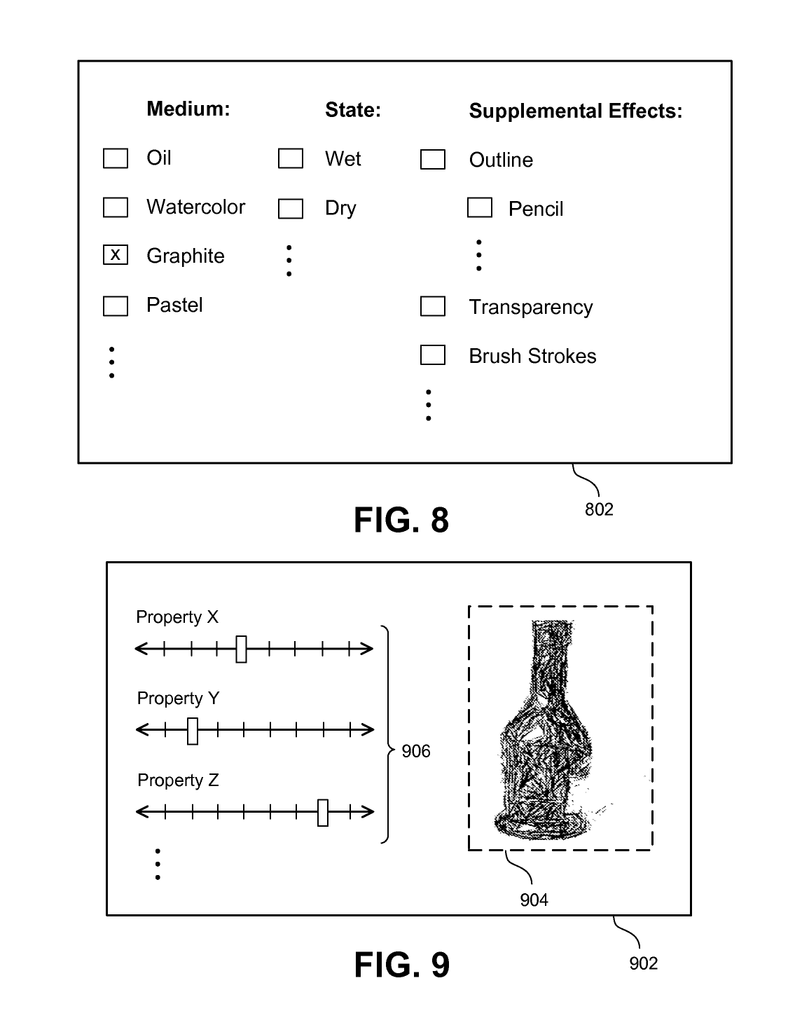

The processing selection module 204 can solicit selections from the user using any user interface strategy. For instance, FIG. 8 shows an option selection interface 802 that represents one way of receiving the user's selections. The option selection interface 802 includes a first series of choices by which a user may specify the medium (or plural media) that is to be associated with the input image. The option selection interface 802 includes a second series of choices by which a user may specify the state of each medium (e.g., indicating whether it is wet or dry). The option selection interface 802 includes a third series of choices by which a user may specify supplemental effects (if any) to be applied to the input image. Although not show, the option selection interface 802 can include an additional series of choices by which a user may select general and/or artist-specific styles. In the particular example of FIG. 8, the user has selected just one option, e.g., by designating the medium as graphite.

In other cases, the processing selection module 204 can automatically select one or more options on the behalf of the user, that is, as default selections. For example, the processing selection module 204 can automatically designate the medium state as wet, unless the user explicitly overrides this selection and chooses a dry state. Further, in some cases, certain options need not (or cannot) be chosen because they do not make sense in the context of other selections. For example, consider a medium that is always interpreted as “flat,” meaning that it lacks a varying height profile, by definition; here, the user may be precluded from selecting the “brush stroke” option, which adds ridges to the applied paint.

As shown in FIG. 9, the filtering module 206 may produce an effect-adjustment interface 902 in response to the user's selections in FIG. 8. The effect-adjustment interface 902 may include a panel 904 which displays a transformed version of the input image, as per the selection made by the user via the processing selection module 204. Here, the filtering module 206 has replaced the photograph of a bottle with a simulated graphite drawing of the bottle. This effect is produced by applying an appropriate filter to the input image.

The effect-adjustment interface 902 can also provide one or more control mechanisms 906 which allow the user to adjust the filtering effect that is being applied to the input image. For example, one control mechanism, in the context of FIG. 9, may allow a user to select the width of the drawing strokes. Another control mechanism may allow a user to select the density of the drawing strokes. Another control mechanism may allow the user to select the color of the drawing strokes, and so on. In the case of FIG. 9, the control mechanisms 906 correspond to slider bars, allowing the user to select values within specified ranges of values. But the effect-adjustment interface 902 can use any type of control mechanisms to accomplish the same effect, e.g., knobs, input boxes, menus, radio buttons, and so forth.

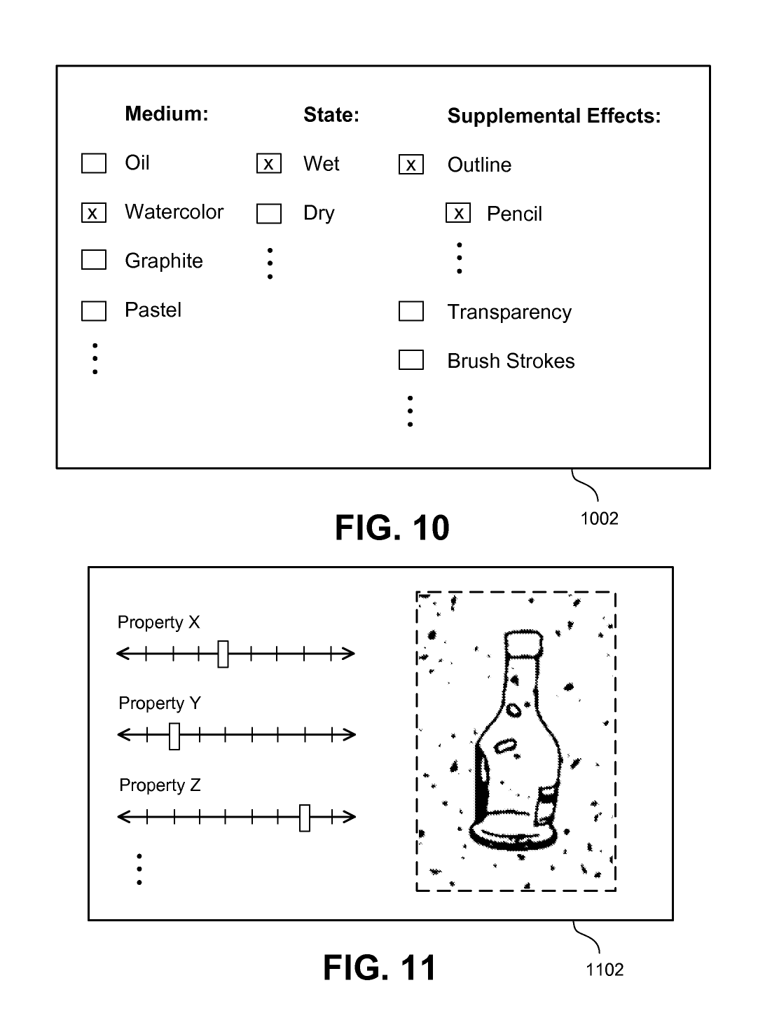

FIG. 10 shows another option selection interface 1002. Here, the user has specified that the medium type is watercolor, and the state of that watercolor paint is wet. The user has further specified that the transformed image will emphasize the edges of the image content in the input image, and graphite will be used to represent the edges. Here, then, is an example in which the transformation mechanism 126 can interpret an input image as being made up of two media types, namely watercolor and graphite. FIG. 11 shows an effect-adjustment interface 1102 that represents the outcome of the selection made via the option selection interface 1002 of FIG. 10.

Although not shown, suppose that the user selected the “transparency” option in the option selection interface 1002 of FIG. 10, instead of the “outline” option. This option instructs the transformation mechanism 126 to produce a color-faded version of the input image. The transformation mechanism 126 can perform this task in different ways. In one approach, the transformation mechanism 126 can adjust the color values in the input image by blending them with a neutral color, such as white. This operation produces a washed-out color effect in the resultant transformed image. In another case, the transformation mechanism 125 can adjust the color values in the input image by blending them with any underlying content (when the input image is placed in the painting interface), to thereby give the impression that the imported image content is semitransparent.

Although not shown, the user can also select two or more medium options within the first column of options in FIG. 10. The transformation mechanism 126 can interpret the input image as being composed of two or more corresponding kinds of media. The transformation mechanism 126 can use any application-specific rules to allocate particular media to different portions of the input image. For example, in one merely illustrative case, the transformation mechanism 126 can distinguish between the foreground portions and the background portions of the input image, and then allocate one medium to the foreground portion and another medium to the background portion. The option selection interface 1002 may also allow the user to manually specify the manner in which different types of paint are to be assigned to different portions of the input image.

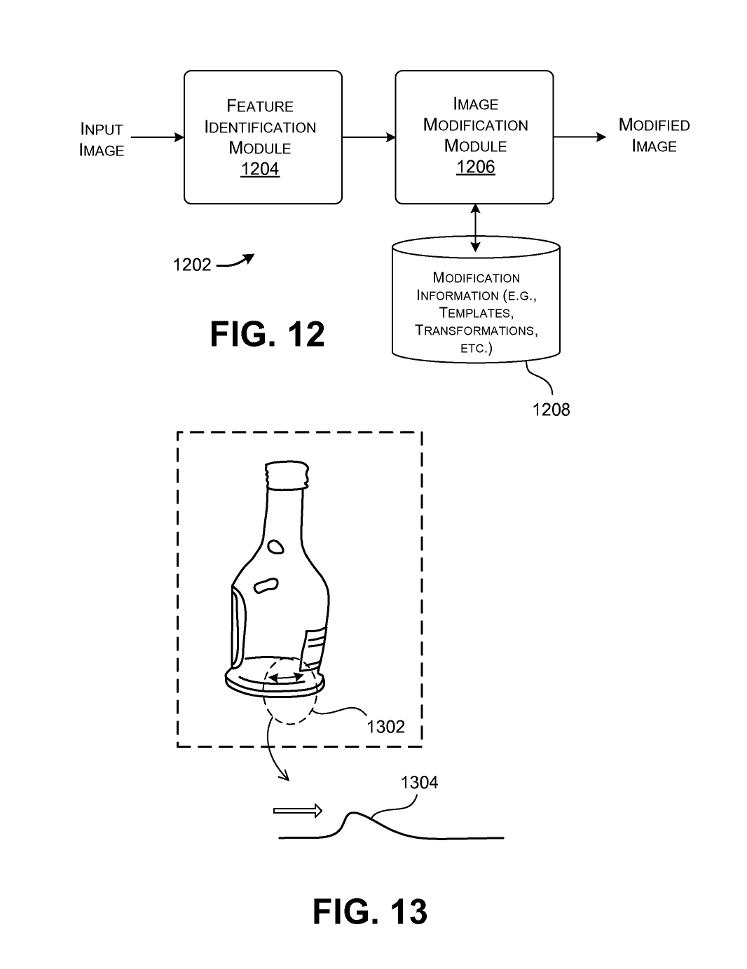

FIG. 12 shows an illustrative filter 1202 that can be used to produce many types of effects. The filter 1202 includes a feature identification module 1204 that analyzes the input image to identify one or more telltale features in the input image. This operation yields a set of features. An image modification module 1206 then modifies the image in a prescribed manner for each identified feature. This operation provides a transformed image. A data store 1208 provides modification information which enables the image modification module 1206 to perform its modification task. The modification information may include templates, patterns, parameters, algorithms, etc.

In one case, the filter 1202 is implemented by code that runs on one or more CPUs (central processing units) of a computer device. In another case, the filter 1202 is implemented, at least in part, by code that runs on one or more GPUs (graphical processing units) of the computer device. For example, without limitation, the filter 1202 can employ pixel shaders to perform its computations on a per-pixel basis. The processing can be performed in multiple stages. The output of each stage may be fed to a buffer, where it then serves as input to the next stage.

FIG. 13 illustrates one application of the filter 1202 of FIG. 12. In this case, the filter 1202 is used to add ridges to an input image that is being interpreted as being expressed in wet oil paint. In a first stage, the feature identification module 1204 is used to detect edges in the input image. The feature identification module 1204 can use any technique(s) for performing this task, such as by using any of a Canny edge detector, a Hough transform, a Gabor filter, a Sobel operator, a Prewitt operator, and so on. Generally, each edge may be considered as a vector having a prescribed position and orientation within the input image. FIG. 13 shows one such vector within a region 1302 of the input image (e.g., corresponding to the double-headed arrow).

In a second stage, the image modification module 1206 adds ridges to the input image. In one approach, the image modification module 1206 can apply the ridges such that they run generally parallel to nearby vectors identified by the feature identification module 1204. This principle for creating ridges is cited by way of example, not limitation. In other cases, the image modification module 1206 can select an image template from the data store 1208 that provide a stock sample of oil paint having ridges. The image modification module 1206 can then randomly apply that pattern across the input image. In one case, the image modification module 1206 can choose the distance between adjacent ridges based on a user-specified brush width setting, or based on a default setting, etc.

FIG. 13 also shows a height profile of an exemplary ridge 1304. The ridge includes a local increase in height values to simulate the effect in which wet paint accumulates at the periphery of a brush footprint (and/or between the bristles of the brush) as the brush moves across a canvas.

The filter 1202 can produce the graphite drawing shown in FIG. 9 using similar principles to those described above. For example, the filter can detect the edges in the input image. These edges correspond to vectors. The filter 1202 can then apply drawing strokes which run generally parallel to nearby vectors. In addition, or alternatively, the filter 1202 can apply a stock pattern of drawing strokes across the input image in random fashion. That stock pattern, for example, may provide a crosshatching pattern or the like.

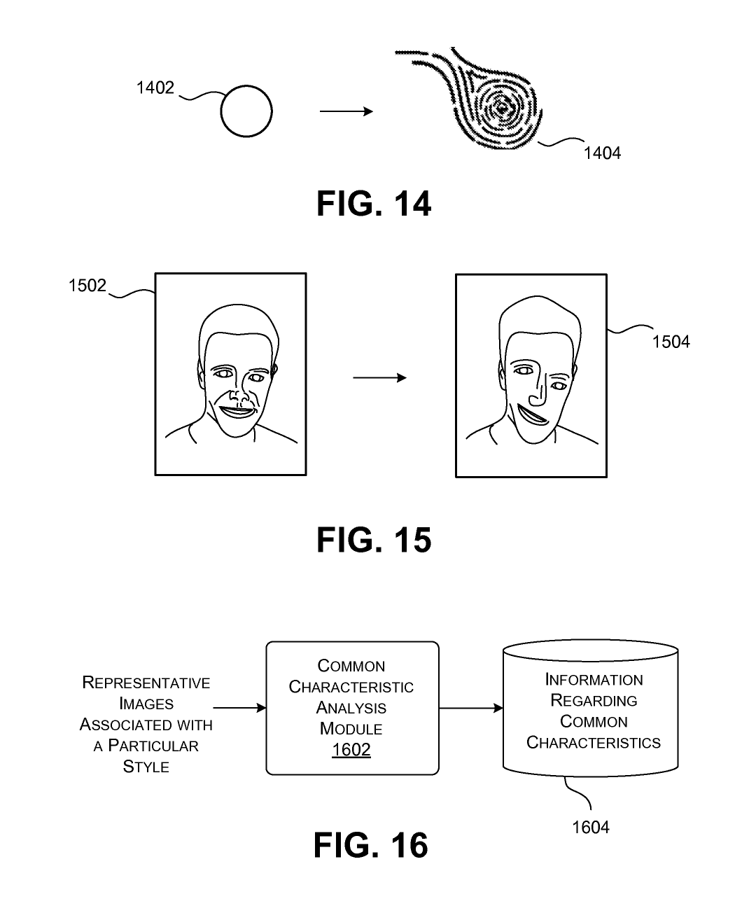

FIG. 14 illustrates another application of the filter 1202 of FIG. 12. In this case, the filter is used to transform an image so that it conforms, in some respects, to a painting that the artist Van Gogh might have produced. In a first stage, the feature identification module 1204 is used to detect certain telltale features in the image. One such feature might be a bright and generally circular object 1402, against an otherwise dark background. In a second stage, the image modification module 1206 can replace the object 1402 with a generally swirling and radiating pattern 1404 (which is stored as a template in the data store 1208). From a higher-level perspective, the aim of the filter 1202 in this instance is to replace objects that might represent celestial objects against a night sky with expressive swirling patterns, reminiscent of Van Gogh's famous Starry Night painting.

In addition, the transformation mechanism 126 can apply another filter that simulates the application of a copious amount of paint to a canvas. This effect is again characteristic of many of Van Gogh's paintings. The filter can achieve this effect by producing a relatively large number of ridges, and producing ridges having comparatively large height values.

FIG. 15 shows another application of the filter 1202 of FIG. 12. In this case, the filter is used to transform an input image 1502 so that it conforms to a modern style, such as that which might be painted by the artist Pablo Picasso. In a first stage, the feature identification module 1204 is used to detect certain telltale features in the input image 1502. For example, the feature identification module 1204 can apply face recognition technology to determine whether the input image contains the face of a human subject, and if so, to detect the prominent features of that face (e.g., eyes, nose, mouth, etc.). In a second stage, the image modification module 1206 can distort the face of the subject in prescribed ways, to produce the transformed image 1504. For example, the image modification module 1206 can shift one or more eyes of the human subject. The image modification module 1206 may also replace one or more features of the human subject (such as the nose) with a stock abstract version of these features. The image modification module 1206 can perform these transformations based on templates and algorithms specified in the data store 1208.

In general a style-related filter can perform any of the following transformations on the input image, to provide a style-converted version of the input image. In a first technique, the filter can replace colors used in the input image with colors that are typically used in the designated style. For example, for a Rembrandt filter, the filter can replace the background of an image which depicts a human subject with a dark-colored and earthy-toned background. In a second technique, the filter can replace shapes used in the image with shapes that are typically used in the designated style. In a third technique, the filter can apply paint to the input image in a manner that is commonly used in the designated style. In a fourth technique, the filter can add thematic or idiosyncratic features to an input image that are commonly used in the designated style. These techniques are cited by way of example, not limitation.

In one case, a style-related filter can modify an original painting by replacing certain original portions with new portions, without preserving any aspects of the original portions. Alternatively, or in addition, a style-related filter can modify the original portions based on reference content, such that the resultant painting reflects the contributions of both the original portions and the reference content. For example, the style-related filter can blend old and new colors, and/or can average old and new shapes, etc.

In one approach, a style-related filter can apply its effects to a user's painting at a particular time specified by the user. In another case, the style-related filter can apply its affects in real time as the user paints. For example, once the style-related filter detects that the user has painted the object 1402 shown in FIG. 14, it may transform it into the pattern 1404.

FIG. 16 shows an analysis module 1602 for determining common characteristics of a series of images that conform to a particular general style or artist-specific style. For example, the analysis module 1602 can be used to determine common characteristics in paintings produced by the artist Paul Gauguin. To perform this task, the analysis module 1602 receives a collection of images that belong to the designated style, e.g., a collection of images of paintings produced by the artist Paul Gauguin. The analysis module 1602 can then identify the common characteristics of these images. For example, the analysis module 1602 can form a histogram of colors used in this artist's paintings to determine the colors that this artist frequently used in his or her paintings. The analysis module 1602 can also determine an extent of color variation in the input images; in the case of Gauguin, the analysis module 1602 would discover that the paintings contain relatively large mono-colored regions. The analysis module 1602 can also perform image comparison analysis to identify common shapes in the paintings. The analysis module 1602 can perform yet other analyses of the input images. Finally, the analysis module 1602 can store its findings in a data store 1604. A developer may then design a filter which leverages the information stored in the data store 1604.

A.3. Illustrative Painting Mechanism

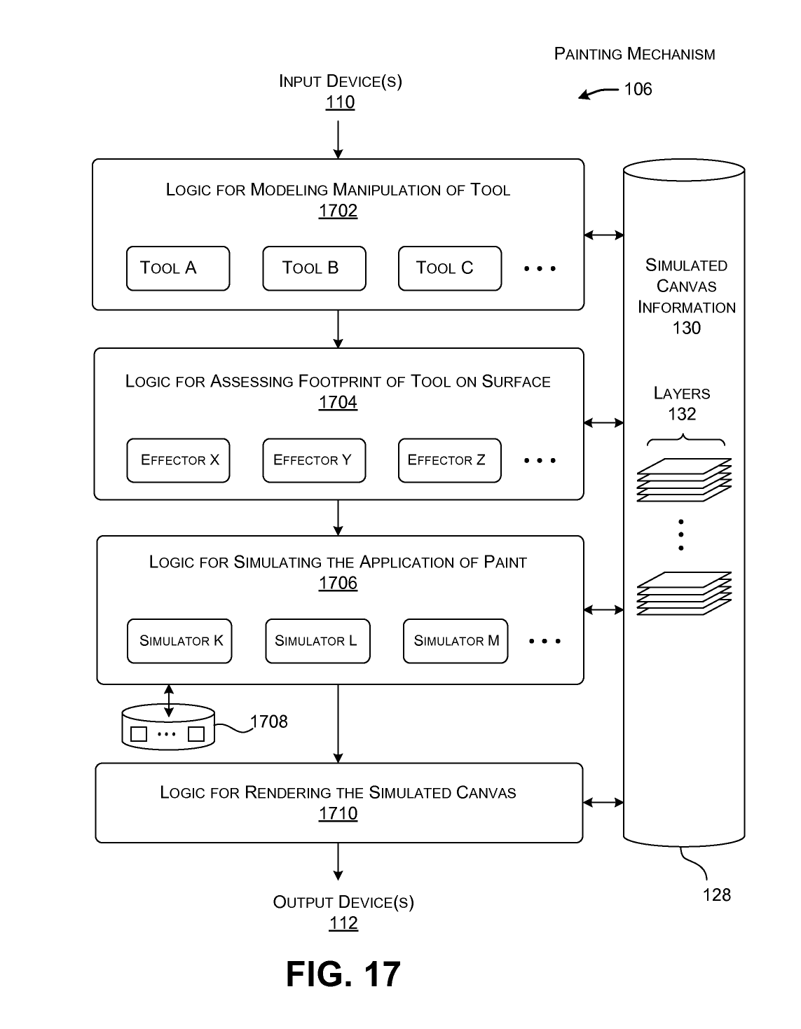

FIG. 17 shows one illustrative implementation of the painting mechanism 106 of FIG. 1. The painting mechanism 106 is used to produce an artwork based on initial image content produced using the import functionality 104 in the manner described above. However, the painting system 102 is agnostic with respect to the particular kind of painting mechanism 106 that is used to produce the artwork. Hence, the details of the painting mechanism 106 described below are to be interpreted as illustrative, rather than limiting. This characteristic also means that different painting mechanisms can be “plugged into” the painting system 102 of FIG. 1.

To begin with, the painting mechanism 106 can include a configuration module (not shown) which allows the user to choose the properties of the canvas substrate on which the user will apply simulated paint. For instance, the user may select the size, absorbency, permeability, fiber orientation, texture, color, etc. of the canvas substrate.

The painting mechanism 106 also includes a logic component 1702 for modeling the characteristics and behaviors of different types of simulated tools, e.g., simulated tool A, simulated tool B, simulated tool C, etc. The simulated tools correspond to different mechanisms by which a user can apply paint to the surface of the simulated canvas, or remove paint from the simulated canvas, or perform some other operation (such as blending) with respect to paint that is already applied to the simulated canvas. The simulated tools can include, but are not limited to, brushes, pencils, crayons, smudge tools, erasers, palette knives, air brushes, and so on.

In operation, the logic component 1702 receives input from the user via the input devices 110. The input describes the manner in which the user is manipulating the simulated tool. The user can perform this task in any manner, such as by using a mouse device, finger placed on a touchscreen, or other input device to define the path of a brush stroke across the simulated canvas. The input may also specify the pressure at which the user is applying the simulated tool to the surface of the simulated canvas. Alternatively, the user may provide input which represents the flicking of a simulated brush towards the canvas, and so on. In response to these inputs, the logic component 1702 can simulate the behavior of the selected simulated tool. Known techniques can be used to perform this task; for example, known techniques can be used to simulate the deflection of brush bristles as the user virtually contacts the surface of the simulated canvas with a brush tool.

A logic component 1704 models the manner in which the simulated tools apply paint to the simulated canvas. The logic component 1704 can perform this task by invoking different effectors, e.g., effector X, effector Y, effector Z, etc. Each effector simulates the manner in which a tool may interact with the surface of the simulated canvas to deposit paint on the canvas, when used in a particular manner. More specifically, a single tool can invoke different effectors depending on how it is used. For example, consider a brush tool. A user can manipulate the brush tool such that it drags across the surface of the simulated canvas. This action invokes a first effector which models, at each instance of time, the footprint of the brush as it moves across the canvas. A user can alternatively provide input which indicates that he or she is flicking the same brush towards the canvas, without touching the canvas. This action invokes other effectors, each of which models the footprint of a drop of paint produced by the flicking motion.

More specifically, each effector can determine the footprint that a simulated tool makes with the simulated canvas based on plural factors, such as the geometry of the simulated tool, the manner in which the user is manipulating the simulated tool at a particular instance of time, the texture of the canvas substrate, and so on. In some implementations, the painting mechanism 106 can use a physics simulator component to determine the footprint based on the above-described factors.

A logic component 1706 invokes one or more simulators, such as simulator K, simulator L, simulator M, etc. Each simulator simulates the effect that paint has when applied to the canvas, for a particular type of medium. For example, the logic component 1706 may invoke a watercolor simulator to simulate the dynamic dispersion of watercolor paint in the simulated canvas. The logic component 1706 may invoke an oil simulator to simulate the generation of ridges on the simulated canvas, and the mixing of new oil paint with existing oil paint, and so on.

The logic component 1706 may use one or more media adhesion matrices stored in a data store 1708 to determine the effects of adding a first type of paint, associated with a new paint stroke, to a second type of paint, associated with an existing paint stroke that has been previously applied to the simulated canvas. The logic component 1706 can perform this analysis on an element-by-element basis (e.g., a pixel-by-pixel basis). That is, the logic component 1706 can determine, for each position in the footprint identified by the logic component 1704: (1) the type of paint that is being applied to the simulated canvas; (2) the type of paint that already exists on the simulated canvas (if any); and (3) the interaction behavior of the two types of paint. The two types of paint may be the same or different.

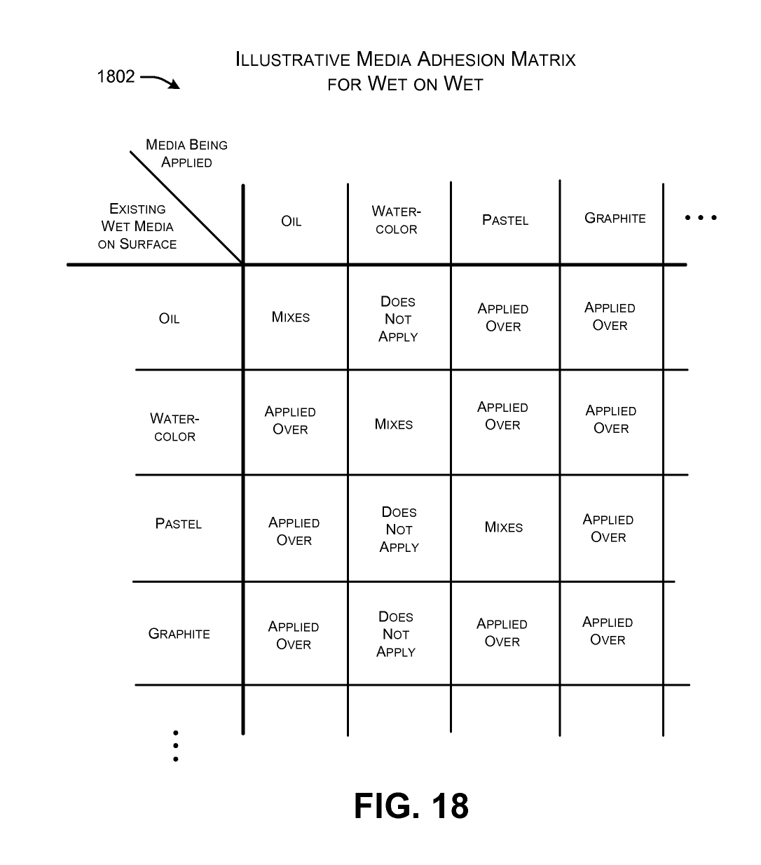

For example, FIG. 18 shows a media adhesion matrix 1802 that describes the media interaction behavior upon adding a wet new paint stroke to an existing wet paint stroke. More specifically, this matrix 1802 identifies three illustrative types of behaviors. An “applied over” behavior indicates that the new paint stroke will be applied over the existing paint stroke, without interacting with the existing paint stroke. A “does not apply” behavior indicates that the new paint stroke will not adhere to the existing paint stroke. A “mixing” behavior indicates that the color values in the new paint stroke will mix with the color values in the existing paint stroke. One or more other matrices can describe the effect of adding wet paint to dry paint. One or more other matrices can describe the effect of combining paint when using different types of tools.

A logic component 1710 renders a depiction of the simulated canvas. The logic component 1710 can then present that depiction to the user using any output devices 112, such as a display device, a printer, and so on. The rendering operation performed by the logic component 1710 can take into account such factors as scaling effects, zoom level, panning effects, shadow effects, and so on.

All of the above-described logic components may interact with a data store 128 that stores the simulated canvas information 130, which represents the simulated canvas. As described in Subsection A.1, the simulated canvas information 130 may include a plurality of layers 132. One or more layers may be associated with each media type that can be applied to the simulated canvas. The logic component 1706 and logic component 1710 can produce a visual representation of the simulated canvas information 130 at any given time by identifying the paint formed on the various layers 132, and by considering the interaction behavior of these layers 132, as defined by the media adhesion matrix or matrices.

FIG. 19 shows one way of representing an oil medium in the simulated canvas information 130. That is, the simulated canvas information may dedicate a wet oil layer 1902 for representing wet oil paint that has been added to the simulated canvas. The simulated canvas information may dedicate a dry oil layer 1904 for representing wet oil paint that has been added to the simulated canvas, but where that oil paint is now dry. Furthermore, the oil paint simulator can dynamically modify the wet oil layer 1902 and the dry oil layer 1904 to reflect a drying process.

For example, in the example of FIG. 20, in a first state 2002, the dry oil layer 1904 includes color values C_{1,d}, C_{2,d}, C_{3,d}, etc., and height values H_{1,d}, H_{2,d}, H_{3,d}, etc. The color values reflect the colors associated with individual elements (e.g., pixels), while the height values reflect the height of paint on the canvas surface for individual elements. The wet oil layer 1902 includes color values C_{1,3}, C_{2,w}, C_{3,w}, etc. and height values H_{1,w}, H_{2,w}, H_{3,w}, etc.

At a second state 2004, assume that the wet paint is considered to have dried. The oil paint simulator models this effect by producing a new dry layer that includes the new color values C′_{1,d}, C′_{2,d}, C′_{3,d}, etc., and the new height values H′_{1,d}, H′_{2,d}, H′_{3,d}, etc. The new color values may correspond to the colors values (C_{1,w}, C_{2,w}, C_{3,w}, etc.) of the wet oil layer 1902 in the state 2002, since the new paint is applied over the old paint, effectively covering up the old dry paint. The new height values may represent the per-element addition of the height values for the wet oil layer 1902 (in state 2002) with the respective height values for the dry oil layer 1904 (in state 2002). Although not shown, the oil simulator can simulate the mixing of colors when new wet oil paint is added to existing wet oil paint.

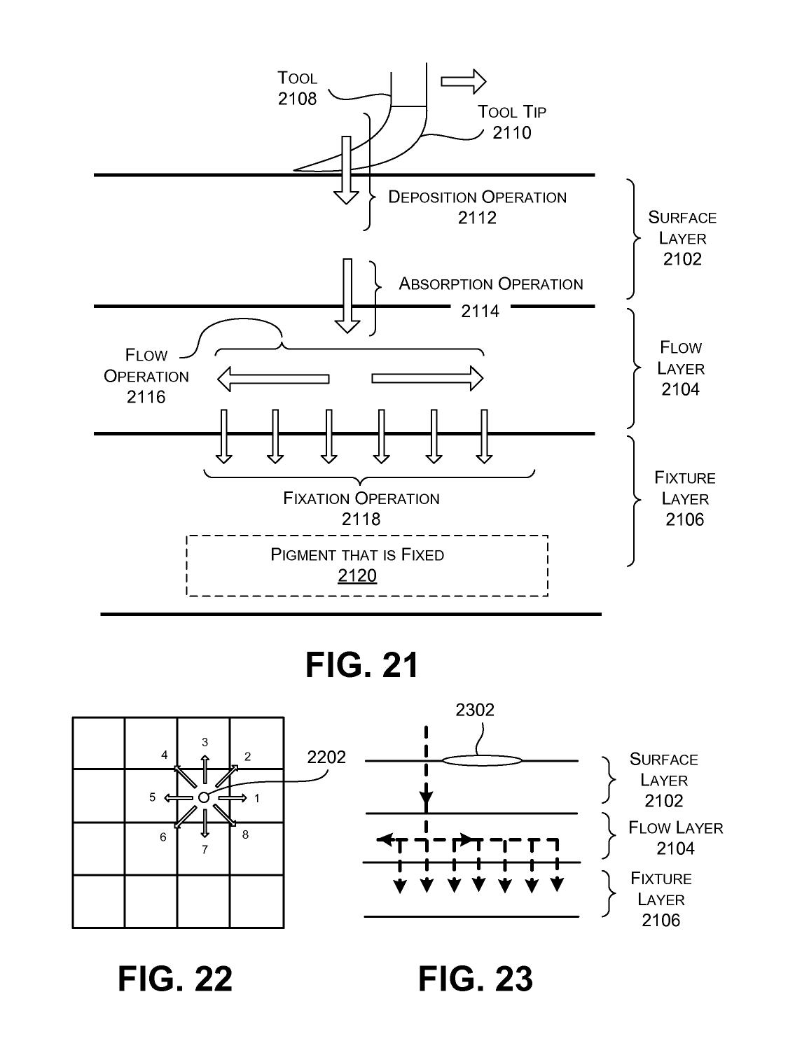

FIGS. 21-23 show techniques by which a watercolor simulator can simulate the movement of watercolor through canvas. To begin with, FIG. 21 shows a high-level representation of a three-level model of the simulated canvas. The model includes a surface layer 2102, a flow layer 2104, and a fixture layer 2106. A tool 2108 deposits watercolor paint onto the surface layer 2102, e.g., using a brush-type tool tip 2110, or some other mode of application. The watercolor paint itself can be modeled as having at least three basic constituents: water, pigment, and glue. The pigment produces the color of the watercolor paint. The pigment moves with the water, as well as within the water. The glue influences the viscosity of the watercolor paint. The glue can also move with the water, and well as within the water.

FIG. 21 also depicts the movement of watercolor paint within the simulated canvas. In a deposition operation 2112, the tool 2108 deposits watercolor paint on the surface layer 2102. In an absorption operation 2114, the watercolor paint seeps from the surface layer 2102 to the flow layer 2104 at a rate determined, in part, by the wetness level of the underlying flow layer 2104. In a flow operation 2116, the watercolor paint laterally disperses in the flow layer 2104. In a fixation operation 2118, the water in the flow layer 2104 evaporates at a prescribed rate. Concurrently therewith, pigments in the watercolor paint move into the fixture layer 2106 as a function of time. Upon the final disappearance of all fluid from a cell (in the flow layer 2104), all pigment remaining in the flow layer 2104 (for that cell) is moved into the fixture layer 2106.

The painting mechanism 106 represents the appearance of the watercolor paint during the drying process by combining the pigments in the surface layer 2102, the flow layer 2104, and the fixture layer 2106. But when the watercolor paint has fully dried, the fixture layer 2106 holds all of the pigments 2120 deposited by the watercolor paint.

FIG. 22 describes the use of the Lattice Boltzmann Equation (LBE) to simulate the movement of fluid in the flow layer 2104. The LBE technique entails partitioning a simulation space into a lattice of discrete elements. The LBE technique then repetitively applies a two-stage analysis to the elements in the lattice. In a first streaming stage, for each element, the LBE technique simulates movements of particles from neighboring elements. In a second, or “collision” stage, for each element, the LBE technique simulates the collision of particles within that same element.

More specifically, a position x 2202 identifies an element within a lattice in a D2Q9 lattice model. In the streaming phase, the LBE technique simulates the movement of particles in nine discrete directions with respect to x, defined by vectors (e₀, e₁, e₂, . . . e₈). FIG. 22 labels these directions with arrows. The vector e₀ corresponds to no movement of particles. The LBE technique simulates the movements of particles in each direction using a distribution function ƒᵢ (x, t), where t represent time, and i corresponds to one of the nine directions. In the collision phase, the LBE technique computes the manner in which the distribution functions are redistributed towards their respective equilibrium functions ƒᵢ^{(eq)}. Different known techniques can be used to implement the LBE technique.

FIG. 23 illustrates behavior that may be produced when a user applies a hydrophobic paint stroke 2302 (e.g., an oil paint stroke) to the surface layer 2102 of the simulated canvas, followed by watercolor paint adjacent to the hydrophobic paint stroke 2302. The dashed-line arrows indicate the possible path that the watercolor paint may take as it moves through the simulated canvas. As indicated, the watercolor paint may seep from the surface layer 2102 to the flow layer 2104. In the flow layer 2104, the watercolor paint may flow in a lateral direction. In so doing, the watercolor paint can potentially tunnel completely under the hydrophobic paint stroke 2302. As the watercolor paint dries it deposits its pigment in the fixture layer 2106. Hence, there is a possibility that the color from the watercolor paint will be visible on both sides of the hydrophobic paint stroke 2302.

To repeat, the painting system 102 can use any painting mechanism in conjunction with the import functionality 104. Further, without limitation, the painting mechanism 106 can use any logic disclosed in the following co-pending U.S. patent applications, each of which is incorporated by reference herein in its entirety: BHATTACHARYAY, et al., “Simulation of Oil Paint on a Canvas,” U.S. application Ser. No. 13/676,501, filed on Nov. 14, 2012; HEROLD, et al., “Digital Art Undo and Redo,” U.S. application Ser. No. 13/677,125, filed on Nov. 14, 2012; and LANDSBERGER, et al., “Simulating Interaction of Different Media,” U.S. application Ser. No. 13/677,009, filed on Nov. 14, 2012.

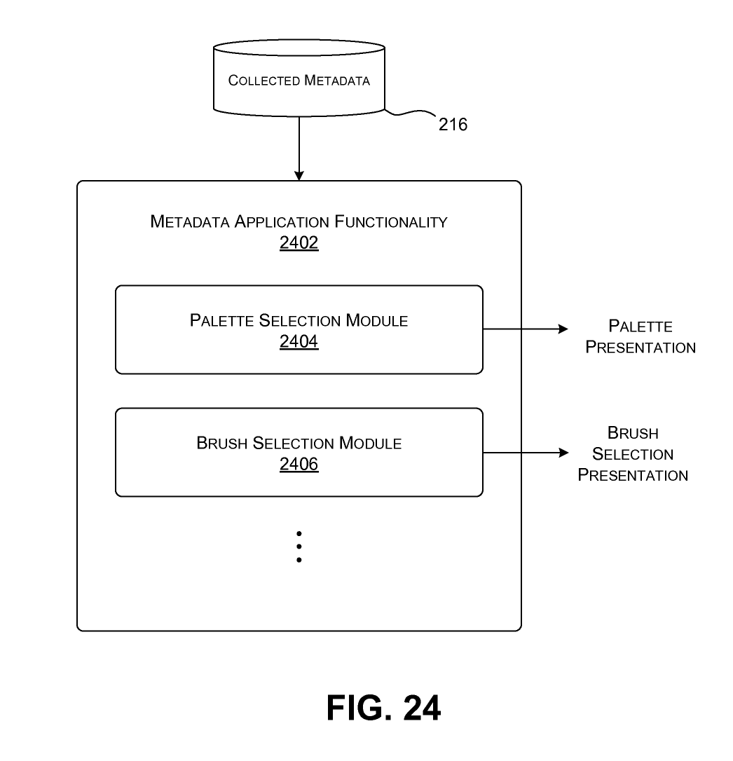

As depicted in FIG. 24, the painting system 102 may also optionally incorporate metadata application functionality 2402. The metadata application functionality 2402 retrieves metadata that has been collected by the metadata collection module 214 of FIG. 2. As explained with reference to FIG. 2, the metadata may identify colors and/or any other characteristics of the input images (and/or the transformed counterparts of the input images). The metadata application functionality 2402 can then use the metadata to modify any aspect of a paint interface generated by the painting mechanism 106, or any other behavior of the paint mechanism 106.

For example, a palette selection module 2404 may identify a set of prominent colors used in the input image (and/or its transformed counterpart image). The palette selection module 2404 can perform this task by selecting the n most prominent colors identified within a color histogram produced by the metadata collection module 214. The palette selection module 2404 can then produce a visual representation of a palette that includes paint regions associated with the identified colors. During the painting process, the user may load up a simulated brush with a particular color by interacting with a corresponding paint region. The user may then apply that paint to the imported image. In addition, the palette selection module 2404 can produce paint regions which correspond to mixtures of one or more of the identified colors.

In addition, the user may manually identify a particular point within the input image or its transformed counterpart image, e.g., by selecting that point with a finger, mouse device, etc. The palette selection module 2404 can identify the color that is associated with the selected point, and assign a paint region in the palette to that color.

Alternatively, or in addition, the metadata application functionality 2402 can include a brush selection module 2406. The brush selection module 2406 can identify metadata (if any) that has a bearing on the characteristics of a painting tool that will be useful in further modifying the imported image. For example, the brush selection module 2406 can use the metadata to identify the type of medium (or media) that have been associated with the input image. In addition, or alternatively, the brush selection module 2406 can use the metadata to determine the spatial characteristics of image content which appears in the input image and/or its transformed counterpart image. The brush selection module 2406 can then map these instances of metadata into a set of one or more tools. The brush selection module 2406 can then present a visual representation of that set of tools, enabling the user to select one of these tools to further modify the imported image.

For example, assume that the input image has been transformed into a wet oil painting, and the input image and/or its transformed counterpart conveys a relatively high degree of detail (which can be inferred based on a spatial frequency assessment, an entropy assessment, etc.). In response, the brush selection module 2406 can select at least one simulated oil brush having a relatively narrow tip size (e.g., which correspondingly produces a narrow footprint on the simulated canvas). The implication here is that, if the input image contains fine detail, the user may wish to modify the input image with a correspondingly fine level of granularity.

The metadata application functionality 2402 can leverage the metadata in yet other ways.

B. Illustrative Processes

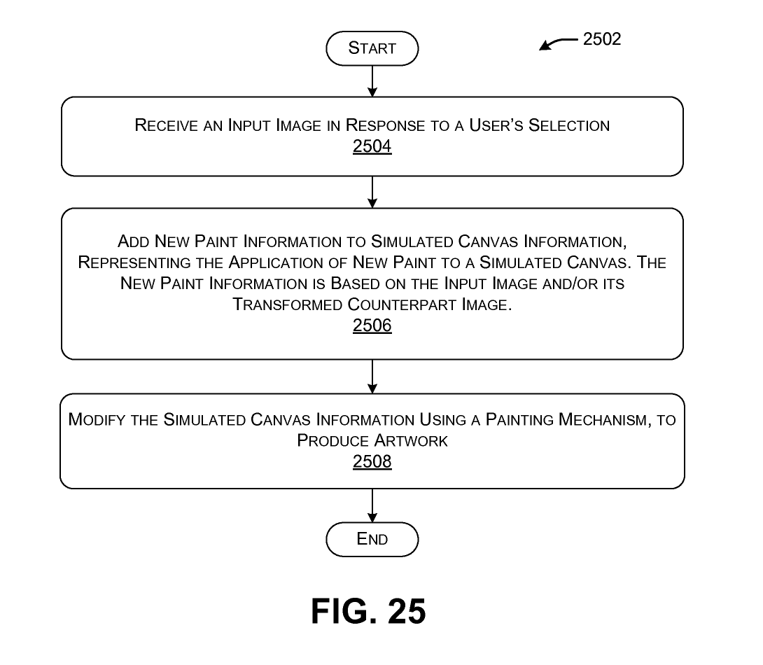

FIGS. 25-28 show procedures that explain one manner of operation of the painting system 102 of FIG. 1. Since the principles underlying the operation of the painting system 102 have already been described in Section A, certain operations will be addressed in summary fashion in this section.

Starting with FIG. 25, this figure shows a procedure 2502 which represents an overview of the painting system 102 of FIG. 1. In block 2504, the painting system 102 receives an input image in response to a user's selection. In block 2506, the painting system 102 adds new paint information to simulated canvas information 130. This operation represents the application of new paint to a simulated canvas. The new paint information is based on the input image and/or its transformed counterpart image (produced by the filtering module 206). In block 2508, the painting system 102 modifies the simulated canvas using the painting mechanism 106, e.g., by adding new strokes to the simulated canvas or by modifying the imported image content.

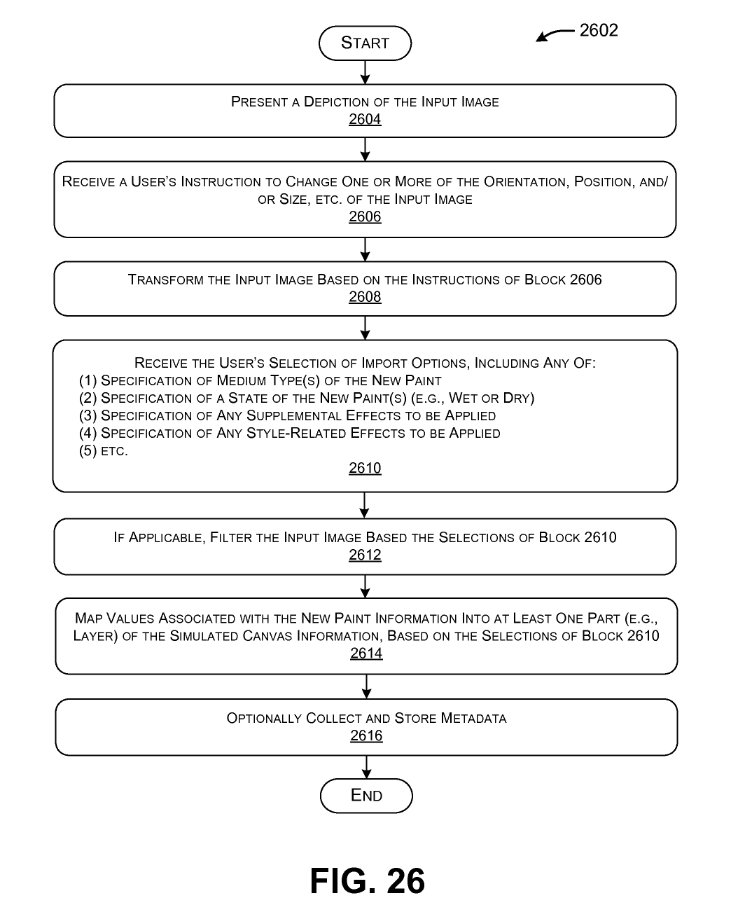

FIG. 26 shows a procedure 2602 which explains one manner of operation of the transformation mechanism 126 of FIG. 1. In block 2604, the transformation mechanism 126 presents a depiction of the input image, e.g., within a manipulation window. In block 2606, the transformation mechanism 126 receives the user's instruction to change one or more of the orientation, position, size, etc. of the input image. In block 2608, the transformation mechanism 126 carries out the instructions specified via block 2606.

In block 2610, the transformation mechanism 126 receives the user's selection of various import options, e.g., via the kinds of option selection interfaces show in FIGS. 8 and 10. In block 2612, the transformation mechanism 126 optionally applies one or more filters to the input image based on the selections made in block 2510, to produce a transformed image. In block 2614, the transformation mechanism 126 maps color values (and optionally depth values, etc.) associated with the new paint information into one or more parts (e.g., layers) of the simulated canvas information, based on the selection made in block 2610. In block 2616. The transformation mechanism 126 can optionally collect metadata of any type described with reference to FIG. 2. Note that the above-described operations can be performed in a different order than is illustrated in FIG. 26.

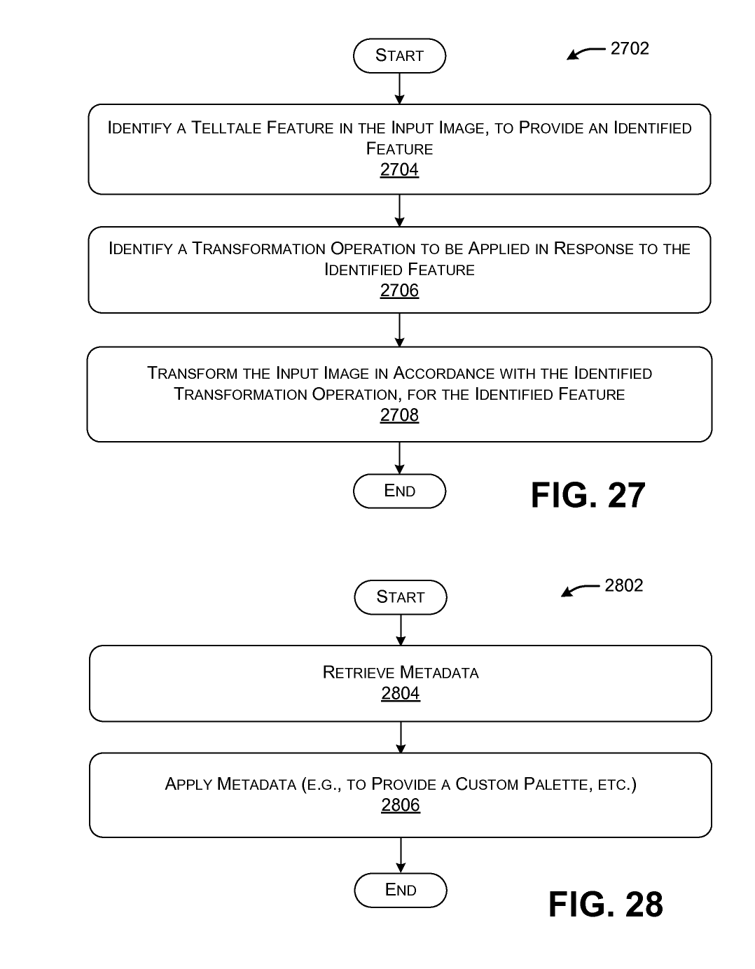

FIG. 27 shows a procedure 2702 for performing one kind of filtering operation, e.g., using the filter 1202 of FIG. 12. In block 2704, the filter 1202 identifies at least one telltale feature in the input image, to provide an identified feature. For example, in the context of FIG. 14, the telltale feature may correspond to a bright spot against an otherwise dark background. In block 2706, the filter 1202 identifies a transformation operation to be applied in response to the identified feature. In block 2708, the filter 1202 transforms the input image in accordance with the identified transformation operation, to produce a transformed image.

FIG. 28 shows a procedure 2802 for applying metadata collected via block 2616 of FIG. 26. In block 2804, the metadata application functionality 2402 retrieves the metadata from the data store 216. In block 2806, the metadata application functionality 2402 applies the metadata in one or more ways, e.g., as described above with reference to FIG. 24.

C. Representative Computing Functionality

FIG. 29 illustrates computing functionality 2902 that can be used to implement any aspect of the painting system 102 of FIG. 1. The computing functionality 2902 may correspond to one or more computer devices.

The computing functionality 2902 can include volatile and non-volatile memory, such as RAM 2904 and ROM 2906, as well as one or more processing devices 2908 (e.g., one or more CPUs 2910, and/or one or more GPUs 2912, etc.). The computing functionality 2902 also optionally includes various media devices 2914, such as a hard disk module, an optical disk module, and so forth. The computing functionality 2902 can perform various operations identified above when the processing devices 2908 execute instructions that are maintained by memory (e.g., RAM 2904, ROM 2906, or elsewhere).

More generally, instructions and other information can be stored on any computer readable medium 2916, including, but not limited to, static memory storage devices, magnetic storage devices, optical storage devices, and so on. The term computer readable medium also encompasses plural storage devices. In many cases, the computer readable medium 2916 represents some form of physical and tangible entity. The term computer readable medium also encompasses propagated signals, e.g., transmitted or received via physical conduit and/or air or other wireless medium, etc. However, the specific terms “computer readable storage medium” and “computer readable medium device” expressly exclude propagated signals per se, while including all other forms of computer readable media.

The computing functionality 2902 also includes an input/output module 2918 for receiving various inputs (via input devices 2920), and for providing various outputs (via output devices). Illustrative input devices include a keyboard device, a mouse input device, a touchscreen input device, a digitizing pad, one or more cameras, a voice recognition mechanism, any movement detection mechanism (e.g., an accelerometer, gyroscope, etc.), and so on. One particular output mechanism may include a presentation device 2922 and an associated graphical user interface (GUI) 2924. The computing functionality 2902 can also include one or more network interfaces 2926 for exchanging data with other devices via one or more communication mechanisms 2928. One or more communication buses 2930 communicatively couple the above-described components together.

The communication mechanisms 2928 can be implemented in any manner, e.g., by a local area network, a wide area network (e.g., the Internet), etc., or any combination thereof. The communication mechanisms 2928 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, performed by one or more computer devices, for producing artwork, comprising:
receiving an input image;
adding, using a transformation mechanism, new paint information to simulated canvas information, representing an application of new paint to a simulated canvas, the new paint information being based on the input image,
wherein said adding comprises:
receiving a selection that identifies a medium type of the new paint; and
mapping values in the new paint information into at least one part of the simulated canvas information that is associated with the medium type; and
modifying, using a painting mechanism, the simulated canvas information in response to input from a user, to produce an artwork,
the transformation mechanism and painting mechanism being implemented by said one or more computer devices.

2. The method of claim 1, wherein the input image corresponds to one or more of:
image content received from a camera device;
image content received from an application of any type;
image content received from a database; and
image content received from a scanning device.

3. The method of claim 1, further comprising:
presenting a depiction of the input image; and
receiving an instruction, from the user, to perform any affine transformation on the input image, to produce placement information,
wherein image content, associated with the new paint information, is placed within the artwork based on the placement information.

4. The method of claim 1, wherein the new paint corresponds to a watercolor medium, and wherein the new paint disperses within the simulated canvas over a span of time following an application of the new paint.

5. The method of claim 1,
wherein said receiving of a selection comprises receiving a selection of two or more medium types, and
said mapping involves mapping values in the new paint information into two or more parts of the simulated canvas information that are associated with said two or more respective medium types.

6. The method of claim 1,
wherein said adding further comprises receiving a selection that identifies a state of the new paint, to provide an identified state, and
wherein said at least one part of the simulated canvas information, to which the new paint information is added, is also associated with the identified state.

7. The method of claim 6, wherein the identified state identifies whether the new paint is wet or dry at a time that the new paint is added to the simulated canvas information.

8. The method of claim 1, further comprising transforming the input image, using at least one filter, into a transformed image,
wherein said transforming comprises one or more of:
producing an outline of image content in the input image based on edges detected in the input image;
producing a ridge-enhanced version of the input image;
producing a color-faded version of the input image; and
producing a style-converted version of the input image based on a specified painting style.

9. The method of claim 1, wherein the simulated canvas information contains no pre-existing paint information at the time that the new paint information is added to the simulated canvas information.

10. The method of claim 1, wherein the simulated canvas information contains pre-existing paint information at the time that the new paint information is added to the simulated canvas information.

11. The method of claim 1, further comprising:
collecting metadata that is based on the input image; and
using the metadata to configure at least one aspect of a paint interface provided by the painting mechanism.

12. The method of claim 1, wherein the input image is associated with a sequence of input images, and wherein said adding is performed in a dynamic manner, as the input images are received.

13. The method of claim 1, wherein the input image is associated with a sequence of input images in a painting tutorial, and wherein each input image in the sequence is associated with a set of painting instructions.

14. A system for producing artwork, comprising:
a data store that stores simulated canvas information that represents a simulated canvas,
the simulated canvas information having plural parts associated with different respective media-related aspects of the simulated canvas information;
a file selection mechanism configured to select an input image, in response to input from a user;
a transformation mechanism configured to add new paint information to the simulated canvas information, the new paint information representing new paint applied to the simulated canvas in a modifiable wet state, and the new paint information being based on the input image; and
a painting mechanism configured to produce artwork by modifying the simulated canvas information.

15. The system of claim 14, wherein said transformation mechanism includes a mapping module, the mapping module being configured to:
receive a selection that identifies a medium type associated with the new paint;
map values associated with the new paint information into at least one part of the simulated canvas information that is associated with the medium type.

16. The system of claim 14,
wherein the transformation mechanism includes a filtering module that includes at least one filter,
the transformation mechanism being configured to use said at least one filter to transform the input image into a transformed image.

17. The system of claim 16, wherein the transformation mechanism is configured to perform one or more of:
producing an outline of image content in the input image based on edges detected in the input image; and
producing a color-faded version the input image.

18. The system of claim 16, wherein the transformation mechanism is configured to produce a ridge-enhanced version of the input image.

19. The system of claim 16, wherein the transformation mechanism is configured to produce a style-converted version of the input image based on a specified painting style.

20. A computer readable storage medium for storing computer readable instructions, the computer readable instructions providing a painting system when executed by one or more processing devices, the computer readable instructions comprising:
logic configured to receive an input image in response to input from a user;
logic configured to identify a medium type and a state of the input image;
logic configured to transform the input image into a transformed image using at least one filter; and
logic configured to add new paint information to at least one part of simulated canvas information that is associated with the medium type and state, the new paint information being based on the transformed image.
